(19) United States
(12) Patent Application Publication
(10) Pub. No.: US 2025/0043079 A1
(43) Pub. Date: Feb. 6, 2025

(54) POLYIMIDE, POLYIMIDE VARNISH, AND POLYIMIDE THIN FILM

(71) Applicants: TOKYO INSTITUTE OF TECHNOLOGY, Meguro-ku, Tokyo (JP); HONSHU CHEMICAL INDUSTRY CO., LTD., Chuo-ku, Tokyo (JP)

(72) Inventors: Shinji ANDO, Meguro-ku, Tokyo (JP); Ririka SAWADA, Meguro-ku, Tokyo (JP); Ryota IMAI, Wakayama-shi (JP); Kazuhisa YAJIMA, Wakayama-shi, Wakayama (JP)

(21) Appl. No.: 18/683,485

(22) PCT Filed: Aug. 22, 2022
(86) PCT No.: PCT/JP2022/031577

§ 371 Date: Feb. 13, 2024

(30) Foreign Application Priority Data
Aug. 24, 2021 (JP) 2021-136454
Nov. 26, 2021 (JP) 2021-192249
Apr. 19, 2022 (JP) 2022-068619
Aug. 19, 2022 (JP) 2022-131038

(51) Int. Cl. C08G 73/10; C08J 5/18; C09D 179/08

(52) U.S. Cl. CPC C08G 73/1085; C08G 73/1057; C08G 73/1071; C08G 73/1082; C08J 5/18; C09D 179/08; C08J 2379/08

(57) ABSTRACT

A polyimide has a repeating unit represented by general formula (1) and having a glass transition temperature (Tg) of 210° C. or higher:

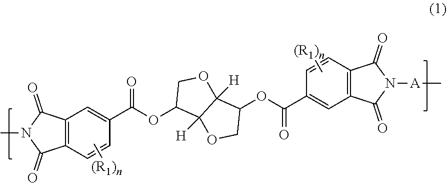

wherein A represents a divalent group represented by general formula (5) or a divalent organic group including a cyclic aliphatic group having 4 to 30 carbon atoms:

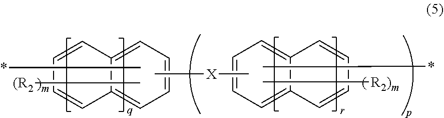

wherein X represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, or a fluorenylidene group, and each * represents a bonding position. The polyimide is intended to have high heat resistance, excellent optical properties, and dielectric properties while being made from a bio-derived resource.

### TECHNICAL FIELD

The present invention relates to a polyimide obtained using a dianhydrohexitol such as isosorbide or isomannide, which is a bio-derived resource raw material, and a tetracarboxylic dianhydride synthesized from a trimellitic anhydride and having an ester bond, and a polyimide varnish obtained from the polyimide, and a polyimide thin film.

### BACKGROUND ART

Polyimides, among current super engineering plastics, are frequently used as highly reliable materials in terms of physical and chemical heat resistance, electric insulation, mechanical properties, flame resistance, and simplicity of production process.

Tetracarboxylic dianhydrides and diamine compounds, which are starting monomers for polyimides, are often produced from petrochemical-derived raw materials. Petrochemical-derived polyimides, because of their high petroleum-derived carbon contents, contribute to greenhouse gas emission. Furthermore, petrochemicals are non-renewable products because petroleum from which they are made is naturally formed over hundreds of thousands of years.

By contrast, bio-based plastics made from bio-derived resources such as plants are considered to be effective in building a sustainable low-carbon society because the carbon in the materials is derived from carbon dioxide fixed by plants. However, most of the bio-based plastics are poor in heat resistance and mechanical properties, and thus have disadvantages in that they can be used in limited applications and are difficult to use as engineering plastics.

For the bio-based plastics to be widely used in state-of-the-art applications such as displays and transparent substrates, the bio-based plastics need to have high heat resistance, chemical stability, and environmental stability and further have excellent optical properties, dielectric properties, and mechanical properties.

### CITATION LIST

### Patent Literature

PTL 1: Chinese Patent Application Publication No. 101648958

### SUMMARY OF INVENTION

### Technical Problem

An object of the present invention is to provide a polyimide material having high heat resistance and also having excellent optical properties and dielectric properties while being made from a bio-derived resource.

### Solution to Problem

To achieve the above object, the present inventors have conducted intensive studies and found that a polyimide obtained using a dianhydrohexitol such as isosorbide or isomannide and a tetracarboxylic dianhydride synthesized from a trimellitic anhydride and having an ester bond can achieve the object, thereby completing the present invention.

The present invention is as follows.
1. A polyimide having a repeating unit represented by general formula (1) below and having a glass transition temperature (Tg) of 210° C. or higher as determined by thermomechanical analysis.

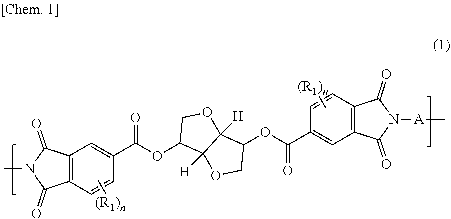

(In the formula, each R₁ independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom, each n independently represents 0 or an integer of 1 to 3, and A represents a divalent group represented by general formula (5) below or a divalent organic group including a cyclic aliphatic group having 4 to 30 carbon atoms.)

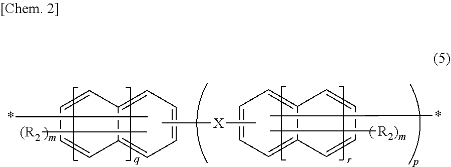

(In the formula, each R₂ independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom, each m independently represents 0 or an integer of 1 to 4, p, q, and r represent 0 or 1, x represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, or a fluorenylidene group, and each * represents a bonding position.)
2. The polyimide according to 1., having one or more repeating units selected from repeating units represented by general formulae (2) to (4) below.

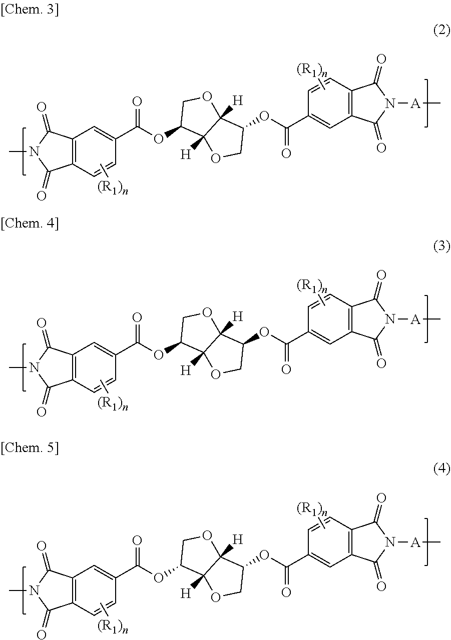

(In general formulae (2) to (4), R₁, n, and A are as defined in general formula (1).)
3. The polyimide according to 1., having a repeating unit represented by general formula (2) below.

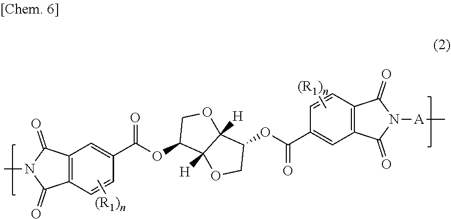

(In the formula, R₁, n, and A are as defined in general formula (1).)
4. The polyimide according to 1, or 2., having two or more repeating units selected from the repeating units represented by general formulae (2) to (4).
5. The polyimide according to 4., having the repeating units represented by general formula (2) and general formula (4).
6. The polyimide according to 5., wherein a molar ratio between the repeating unit represented by general formula (2) and the repeating unit represented by general formula (4) is in a range of (2):(4)=99:1 to 50:50.
7. The polyimide according to 1., wherein a content of the repeating unit represented by general formula (1) is 15 mol % or more of a total amount of the polyimide.
8. A polyimide varnish including the polyimide according to 1, and an organic solvent.
9. A polyimide thin film including the polyimide according to 1.
10. A polyimide having a repeating unit represented by general formula (1) below and having a thermal decomposition temperature (Td) of 350° C. or higher at which a residual weight percentage based on a weight at 100° C. in thermogravimetric analysis reaches 95%.

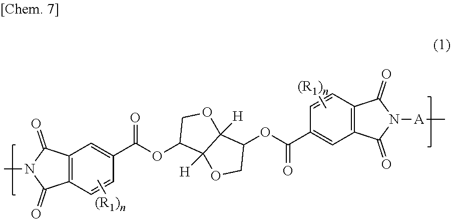

(In the formula, each R₁ independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom, each n independently represents 0 or an integer of 1 to 3, and A represents a divalent organic group.)
11. The polyimide according to 10., having one or more repeating units selected from repeating units represented by general formulae (2) to (4) below.

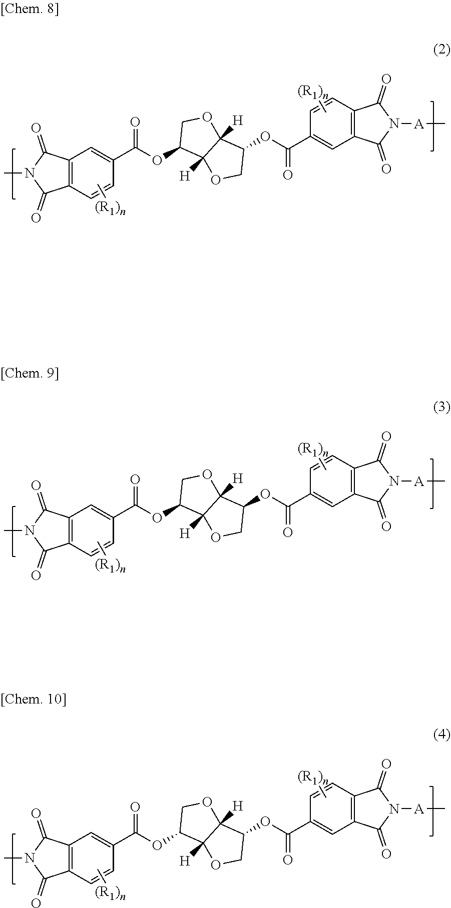

(In general formulae (2) to (4), R₁, n, and A are as defined in general formula (1).)
12. The polyimide according to 10., having a repeating unit represented by general formula (2) below.

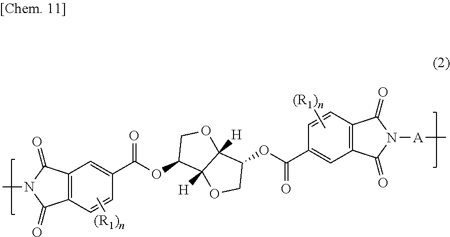

(In the formula, R₁, n, and A are as defined in general formula (1).)
13. The polyimide according to 10. or 11., having two or more repeating units selected from the repeating units represented by general formulae (2) to (4).
14. The polyimide according to 13., having the repeating units represented by general formula (2) and general formula (4).
15. The polyimide according to 14., wherein a molar ratio between the repeating unit represented by general formula (2) and the repeating unit represented by general formula (4) is in a range of (2):(4)=99:1 to 50:50.
16. The polyimide according to 10., wherein A in general formulae (1) to (4) is a divalent organic group including an aromatic ring or a divalent organic group including a linear, branched, or cyclic aliphatic group.
17. The polyimide according to 16., wherein the divalent organic group including an aromatic ring and represented by A in general formulae (1) to (4) is a divalent group represented by general formula (5) below.

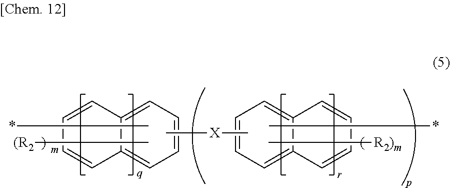

(In the formula, each R₂ independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom, each m independently represents 0 or an integer of 1 to 4, p, q, and r represent 0 or 1, X represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, or a fluorenylidene group, and each represents a bonding position.)
18. The polyimide according to 16., wherein the divalent organic group including a linear, branched, or cyclic aliphatic group is a divalent organic group including a linear or branched aliphatic group having 1 to 30 carbon atoms or a cyclic aliphatic group having 4 to 30 carbon atoms.
19. The polyimide according to 10., wherein a content of the repeating unit represented by general formula (1) is 15 mol % or more of a total amount of the polyimide.
20. A polyimide varnish including the polyimide according to 10. and an organic solvent.
21. A polyimide thin film including the polyimide according to 10.

### Advantageous Effects of Invention

The polyimide according to the present invention can provide a material sufficiently having heat resistance required for polyimide resins and also having excellent optical properties and dielectric properties while being made from a bio-derived resource.

### BRIEF DESCRIPTION OF DRAWINGS

FIG. 1 shows an ATR infrared absorption spectrum of a polyimide thin film (thickness: about 15 μm) obtained in Example 1.

FIG. 2 shows an ATR infrared absorption spectrum of a polyimide thin film (thickness: about 15 μm) obtained in Example 2.

FIG. 3 shows an ATR infrared absorption spectrum of a polyimide thin film (thickness: about 15 μm) obtained in Example 3.

FIG. 4 shows an ATR infrared absorption spectrum of a polyimide thin film (thickness: about 15 μm) obtained in Example 4.

FIG. 5 shows an ATR infrared absorption spectrum of a polyimide thin film (thickness: about 15 μm) obtained in Example 5.

FIG. 6 shows an ATR infrared absorption spectrum of a polyimide thin film (thickness: about 15 μm) obtained in Example 6.

FIG. 7 shows an ATR infrared absorption spectrum of a polyimide thin film (thickness: about 15 μm) obtained in Example 7.

FIG. 8 shows an ATR infrared absorption spectrum of a polyimide thin film (thickness: about 15 μm) obtained in Example 8.

FIG. 9 shows an ATR infrared absorption spectrum of a polyimide thin film (thickness: about 15 μm) obtained in Example 9.

FIG. 10 shows an ATR infrared absorption spectrum of a polyimide thin film (thickness: about 15 μm) obtained in Example 10.

FIG. 11 shows an ATR infrared absorption spectrum of a polyimide thin film (thickness: about 15 μm) obtained in Example 11.

FIG. 12 shows a ¹H-NMR spectrum of a deuterated dimethylsulfoxide (DMSO-d₆) solution of the polyimide thin film obtained in Example 1.

FIG. 13 shows a 1H-NMR spectrum of a DMSO-d₆ solution of the polyimide thin film obtained in Example 2.

FIG. 14 shows a 1H-NMR spectrum of a DMSO-d₆ solution of the polyimide thin film obtained in Example 3.

FIG. 15 shows a 1H-NMR spectrum of a DMSO-d₆ solution of the polyimide thin film obtained in Example 4.

FIG. 16 shows a 1H-NMR spectrum of a DMSO-d₆ solution of the polyimide thin film obtained in Example 5.

FIG. 17 shows a 1H-NMR spectrum of a DMSO-d₆ solution of the polyimide thin film obtained in Example 6.

FIG. 18 shows a 1H-NMR spectrum of a DMSO-d₆ solution of the polyimide thin film obtained in Example 7.

FIG. 19 shows a 1H-NMR spectrum of a DMSO-d₆ solution of the polyimide thin film obtained in Example 8.

FIG. 20 shows a 1H-NMR spectrum of a DMSO-d₆ solution of the polyimide thin film obtained in Example 9.

FIG. 21 shows a 1H-NMR spectrum of a DMSO-d₆ solution of the polyimide thin film obtained in Example 10.

FIG. 22 shows a 1H-NMR spectrum of a DMSO-d₆ solution of the polyimide thin film obtained in Example 11.

FIG. 23 shows a chart of thermomechanical analysis (TMA) of the polyimide thin film obtained in Example 1.

FIG. 24 shows a chart of thermomechanical analysis (TMA) of the polyimide thin film obtained in Example 2.

FIG. 25 shows a chart of thermomechanical analysis (TMA) of the polyimide thin film obtained in Example 3.

FIG. 26 shows a chart of thermomechanical analysis (TMA) of the polyimide thin film obtained in Example 4.

FIG. 27 shows a chart of thermomechanical analysis (TMA) of the polyimide thin film obtained in Example 5.

FIG. 28 shows a chart of thermomechanical analysis (TMA) of the polyimide thin film obtained in Example 6.

FIG. 29 shows a chart of thermomechanical analysis (TMA) of the polyimide thin film obtained in Example 7.

FIG. 30 shows a chart of thermomechanical analysis (TMA) of the polyimide thin film obtained in Example 8.

FIG. 31 shows a chart of thermomechanical analysis (TMA) of the polyimide thin film obtained in Example 9.

FIG. 32 shows a chart of thermomechanical analysis (TMA) of the polyimide thin film obtained in Example 10.

FIG. 33 shows a chart of thermomechanical analysis (TMA) of the polyimide thin film obtained in Example 11.

FIG. 34 shows a chart of thermogravimetric analysis (TGA) of the polyimide thin film obtained in Example 1.

FIG. 35 shows a chart of thermogravimetric analysis (TGA) of the polyimide thin film obtained in Example 2.

FIG. 36 shows a chart of thermogravimetric analysis (TGA) of the polyimide thin film obtained in Example 3.

FIG. 37 shows a chart of thermogravimetric analysis (TGA) of the polyimide thin film obtained in Example 4.

FIG. 38 shows a chart of thermogravimetric analysis (TGA) of the polyimide thin film obtained in Example 5.

FIG. 39 shows a chart of thermogravimetric analysis (TGA) of the polyimide thin film obtained in Example 6.

FIG. 40 shows a chart of thermogravimetric analysis (TGA) of the polyimide thin film obtained in Example 7.

FIG. 41 shows a chart of thermogravimetric analysis (TGA) of the polyimide thin film obtained in Example 8.

FIG. 42 shows a chart of thermogravimetric analysis (TGA) of the polyimide thin film obtained in Example 9.

FIG. 43 shows a chart of thermogravimetric analysis (TGA) of the polyimide thin film obtained in Example 10.

FIG. 44 shows a chart of thermogravimetric analysis (TGA) of the polyimide thin film obtained in Example 11.

FIG. 45 shows an ultraviolet-visible light transmittance spectrum of the polyimide thin film obtained in Example 1.

FIG. 46 shows an ultraviolet-visible light transmittance spectrum of the polyimide thin film obtained in Example 2.

FIG. 47 shows an ultraviolet-visible light transmittance spectrum of the polyimide thin film obtained in Example 3.

FIG. 48 shows an ultraviolet-visible light transmittance spectrum of the polyimide thin film obtained in Example 4.

FIG. 49 shows an ultraviolet-visible light transmittance spectrum of the polyimide thin film obtained in Example 5.

FIG. 50 shows an ultraviolet-visible light transmittance spectrum of the polyimide thin film obtained in Example 6.

FIG. 51 shows an ultraviolet-visible light transmittance spectrum of the polyimide thin film obtained in Example 7.

FIG. 52 shows an ultraviolet-visible light transmittance spectrum of the polyimide thin film obtained in Example 8.

FIG. 53 shows an ultraviolet-visible light transmittance spectrum of the polyimide thin film obtained in Example 9.

FIG. 54 shows an ultraviolet-visible light transmittance spectrum of the polyimide thin film obtained in Example 10.

FIG. 55 shows an ultraviolet-visible light transmittance spectrum of the polyimide thin film obtained in Example 11.

FIG. 56 shows the wavelength dependence of refractive indices (n_{TE}, n_{TM}, nₐᵥ) and birefringence (Δn) of the polyimide thin film obtained in Example 1.

FIG. 57 shows the wavelength dependence of refractive indices (n_{TE}, n_{TM}, nₐᵥ) and birefringence (Δn) of the polyimide thin film obtained in Example 2.

FIG. 58 shows the wavelength dependence of refractive indices (n_{TE}, n_{TM}, nₐᵥ) and birefringence (Δn) of the polyimide thin film obtained in Example 3.

FIG. 59 shows the wavelength dependence of refractive indices (n_{TE}, n_{TM}, nₐᵥ) and birefringence (Δn) of the polyimide thin film obtained in Example 4.

FIG. 60 shows the wavelength dependence of refractive indices (n_{TE}, n_{TM}, nₐᵥ) and birefringence (Δn) of the polyimide thin film obtained in Example 5.

FIG. 61 shows the wavelength dependence of refractive indices (n_{TE}, n_{TM}, nₐᵥ) and birefringence (Δn) of the polyimide thin film obtained in Example 6.

FIG. 62 shows the wavelength dependence of refractive indices (n_{TE}, n_{TM}, nₐᵥ) and birefringence (Δn) of the polyimide thin film obtained in Example 7.

FIG. 63 shows the wavelength dependence of refractive indices (n_{TE}, n_{TM}, nₐᵥ) and birefringence (Δn) of the polyimide thin film obtained in Example 8.

FIG. 64 shows the wavelength dependence of refractive indices (n_{TE}, n_{TM}, nₐᵥ) and birefringence (Δn) of the polyimide thin film obtained in Example 9.

FIG. 65 shows the wavelength dependence of refractive indices (n_{TE}, n_{TM}, nₐᵥ) and birefringence (Δn) of the polyimide thin film obtained in Example 10.

FIG. 66 shows the wavelength dependence of refractive indices (n_{TE}, n_{TM}, nₐᵥ) and birefringence (Δn) of the polyimide thin film obtained in Example 11.

FIG. 67 shows a spectrum showing a circular dichroism ellipticity (CD) of the polyimide thin film (thickness: about 1 μm) obtained in Example 1.

FIG. 68 shows a spectrum showing a circular dichroism ellipticity (CD) of the polyimide thin film (thickness: about 1 μm) obtained in Example 2.

FIG. 69 shows a spectrum showing a circular dichroism ellipticity (CD) of the polyimide thin film (thickness: about 1 μm) obtained in Example 3.

FIG. 70 shows a spectrum showing a circular dichroism ellipticity (CD) of the polyimide thin film (thickness: about 1 μm) obtained in Example 9.

FIG. 71 shows a spectrum showing a circular dichroism ellipticity (CD) of the polyimide thin film (thickness: about 1 μm) obtained in Example 10.

FIG. 72 shows a spectrum showing a circular dichroism ellipticity (CD) of the polyimide thin film (thickness: about 1 μm) obtained in Example 11.

### DESCRIPTION OF EMBODIMENTS

A polyimide according to the present invention has a repeating unit represented by general formula (1) and has a glass transition temperature (Tg) of 210° C. or higher as determined by thermomechanical analysis.

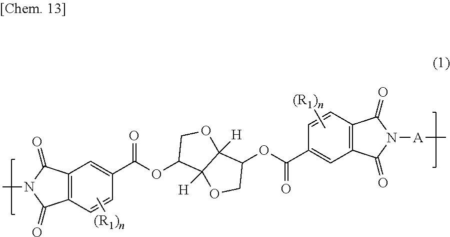

(In the formula, each R₁ independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom, each n independently represents 0 or an integer of 1 to 3, and A represents a divalent group represented by general formula (5) below or a divalent organic group including a cyclic aliphatic group having 4 to 30 carbon atoms.)

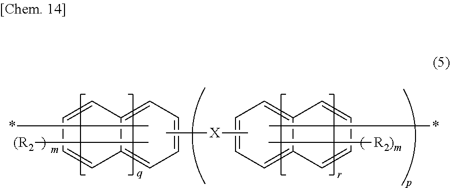

(In the formula, each R₂ independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom, each m independently represents 0 or an integer of 1 to 4, p, q, and r represent 0 or 1, X represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, or a fluorenylidene group, and each * represents a bonding position.)

The polyimide according to the present invention preferably has one or more repeating units selected from repeating units represented by general formulae (2) to (4) below.

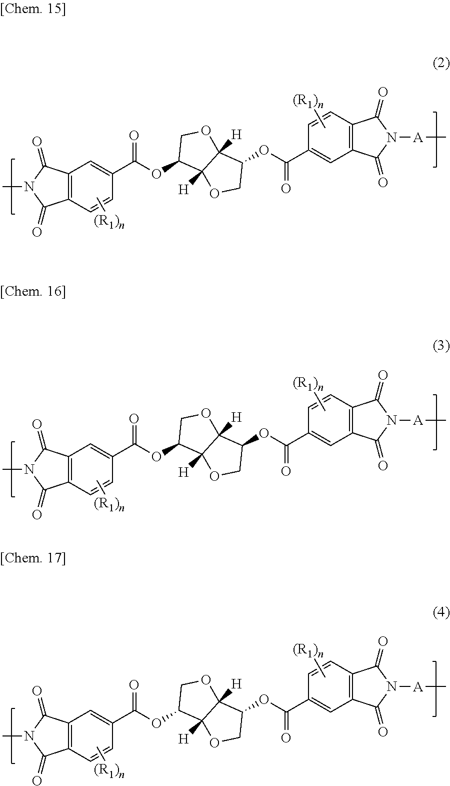

(R₁, n, and A in general formulae (2) to (4) are as defined in general formula (1).)

Of these, the polyimide particularly preferably has the repeating unit represented by general formula (2).

Examples of cases where the polyimide has two or more repeating units selected from the repeating units represented by general formulae (2) to (4) include the case where the polyimide has the repeating units represented by general formula (2) and general formula (3), the case where the polyimide has the repeating units represented by general formula (2) and general formula (4), the case where the polyimide has the repeating units represented by general formula (3) and general formula (4), and the case where the polyimide has the repeating units represented by general formula (2), general formula (3), and general formula (4).

Of these, the polyimide obtained when having the repeating units represented by general formula (2) and general formula (4) is preferred from the viewpoint of high light transmission properties and a decrease in birefringence (Δn). In this case, the molar ratio between the repeating unit represented by general formula (2) and the repeating unit represented by general formula (4) is preferably in the range of (2):(4)=99:1 to 50:50, more preferably in the range of (2):(4)=90:10 to 60:40, still more preferably in the range of (2):(4)=80:20 to 60:40.

Each R₁ in general formulae (1) to (4) independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom.

In particular, R₁ is preferably a linear or branched alkyl group having 1 to 4 carbon atoms, a linear or branched alkyl halide group having 1 to 4 carbon atoms, or a halogen atom, more preferably a linear or branched alkyl halide group having 1 to 4 carbon atoms or a halogen atom, particularly preferably a trifluoromethyl group or a fluorine atom.

Each n in general formulae (1) to (4) independently represents 0 or an integer of 1 to 3. In particular, n is preferably 0, 1, or 2, more preferably 0 or 1, particularly preferably 0.

Each R₂ in general formula (5) above independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom.

In particular, R₂ is preferably a linear or branched alkyl group having 1 to 4 carbon atoms, a linear or branched alkyl halide group having 1 to 4 carbon atoms, or a halogen atom, more preferably a linear or branched alkyl halide group having 1 to 4 carbon atoms or a halogen atom, still more preferably a linear or branched alkyl halide group having 1 to 4 carbon atoms, particularly preferably a trifluoromethyl group.

When R₂ in general formula (5) is an alkyl halide group such as a trifluoromethyl group, the charge-transfer properties in an electronic state formed by the moiety derived from a diamine compound and the moiety derived from trimellitic acid of a tetracarboxylic dianhydride in the ground state decrease, and the light absorption edge shifts from the visible range to the ultraviolet range, which is advantageous in that a polyimide having high light transmission properties in the visible range and also having a low refractive index, a small dielectric constant, and a small dielectric loss tangent is obtained. Here, the light absorption edge refers to a wavelength at which the absorbance steeply increases in an ultraviolet-visible light transmittance spectrum of a polyimide thin film.

Each m in general formula (5) independently represents 0 or an integer of 1 to 4, and is preferably 0, 1, or 2, more preferably 0 or 1.

p in general formula (5) represents 0 or 1, and is preferably 1. When p in general formula (5) is 0, two bonding positions are present on the aromatic ring on the left side in general formula (5). In this case, general formula (5) is represented as general formula (5′) below.

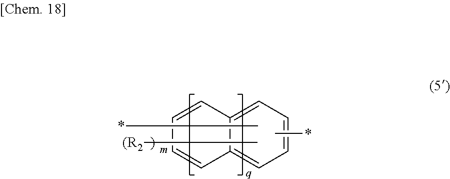

(In the formula, R₂, m, and q are as defined in general formula (5).)

q and r in general formula (5) each independently represent 0 or 1, preferably 0.

When p and q in general formula (5) are 0 (when q in general formula (5′) is 0), that is, when the aromatic ring in the formula is a benzene ring, the two bonding positions represented by * are preferably located in the para or meta positions of the benzene ring. In particular, when the two bonding positions are located in the meta positions, a bent structure of the m-phenylene bond reduces the electron-donating properties of the moiety derived from a diamine compound and inhibits intermolecular aggregation of a polyimide, so that the charge-transfer light absorption shifts to a shorter wavelength, which is advantageous in that a polyimide having high light transmission properties in the visible range and also having a low refractive index is obtained.

X in general formula (5) represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, or a fluorenylidene group. In particular, X is preferably a direct bond, an oxygen atom, a sulfur atom, a sulfonyl group (—SO₂—), a carbonyl group (—CO—), an amide group (—NHCO—), an ester group (—OCO—), an alkylidene group having 2 to 12 carbon atoms, a fluorine-containing alkylidene group having 2 to 12 carbon atoms, a cycloalkylidene group having 5 to 12 carbon atoms, a phenylethylidene group, or a fluorenylidene group, more preferably a direct bond, an oxygen atom, a sulfur atom, a sulfonyl group (—SO₂—), carbonyl group (—CO—), an amide group (—NHCO—), an ester group (—OCO—), an alkylidene group having 2 to 8 carbon atoms, a fluorine-containing alkylidene group having 2 to 8 carbon atoms, a cycloalkylidene group having 6 to 12 carbon atoms, a phenylethylidene group, or a fluorenylidene group, particularly preferably a direct bond, an oxygen atom, a sulfur atom, a sulfonyl group (—SO₂—), an amide group (—NHCO—), an ester group (—OCO—), an alkylidene group having 2 to 4 carbon atoms, a fluorine-containing alkylidene group having 2 to 4 carbon atoms, a cycloalkylidene group having 6 to 9 carbon atoms, or a fluorenylidene group. The bonding positions of the amide group (—NHCO—) and the ester group (—OCO—) are not limited, and, for example, the amide group also includes “—CONH—”.

The cycloalkylidene group having 5 to 15 carbon atoms may include a branched-chain alkyl group. Specific examples of the cycloalkylidene group include a cyclopentylidene group (5 carbon atoms), a cyclohexylidene group (6 carbon atoms), a 3-methylcyclohexylidene group (7 carbon atoms), a 4-methylcyclohexylidene group (7 carbon atoms), a 3,3,5-trimethylcyclohexylidene group (9 carbon atoms), a cycloheptylidene group (7 carbon atoms), and a cyclododecanylidene group (12 carbon atoms).

The divalent organic group including a cyclic aliphatic group having 4 to 30 carbon atoms is preferably a divalent hydrocarbon group including a cyclic aliphatic group having 4 to 30 carbon atoms, and the divalent hydrocarbon group including such an aliphatic group may include a halogen atom such as fluorine. The divalent organic group is more preferably a cyclic divalent aliphatic saturated hydrocarbon group having 4 to 30 carbon atoms, still more preferably a cyclic divalent aliphatic saturated hydrocarbon group having 6 to 20 carbon atoms, particularly preferably a cyclic divalent aliphatic saturated hydrocarbon group having 6 to 12 carbon atoms, and these divalent aliphatic saturated hydrocarbon groups may include a halogen atom such as fluorine.

Specific examples of the divalent organic group including a cyclic aliphatic group having 4 to 30 carbon atoms include a bis(1,4-cyclohexylene)methylene group, a trans-1,4-cyclohexane-diyl group, a cis-1,4-cyclohexane-diyl group, a cyclohexane-1,4-bismethylene group, a bicyclo[2.2.1]heptane-2,5-bismethylene group, a bicyclo[2.2.1]heptane-2,6-bismethylene group, a bicyclo[2.2.2]octane-1,4-diyl group, a decahydronaphthalene-1,4-diyl group, a tricyclo[5.2.1.0]decane-3,8-bismethylene group, an adamantane-1,3-diyl group, an isopropylidenedicyclohexane-4,4′-diyl group, and a hexafluoroisopropylidenedicyclohexane-4,4′-diyl group.

In the case of a divalent organic group including a cyclic aliphatic group having 4 to 30 carbon atoms, the charge-transfer properties in an electronic state formed by the moiety derived from a diamine compound and the moiety derived from trimellitic acid of a tetracarboxylic dianhydride in a polyimide in the ground state decrease, and the light absorption edge shifts from the visible range to the ultraviolet range, which is advantageous in that a polyimide having high light transmission properties in the visible range and also having a low refractive index is obtained. Of the above, a trans-1,4-cyclohexane-diyl group and a cis-1,4-cyclohexane-diyl group are more preferred.

The polyimide according to the present invention, if containing the repeating unit represented by general formula (1) above, may have another skeleton as long as the advantageous effects of the present invention are not impaired.

For example, the polyimide may have a repeating unit represented by general formula (6) below.

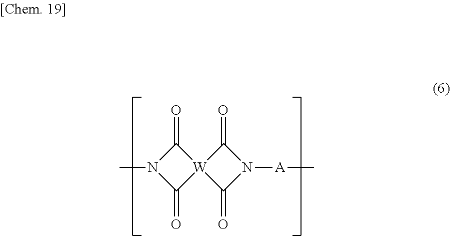

(In the formula, W represents a tetravalent organic group (excluding the tetravalent group represented by general formula (7) below), and A is as defined in general formula (1).)

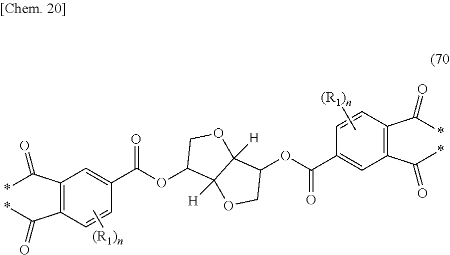

(In the formula, R₁ and n are as defined in general formula (1), and * represents a bonding position.)

The tetravalent organic group represented by W in the repeating unit represented by general formula (6) is preferably any one or more of a structure represented by general formula (8) below, a structure represented by general formula (10) below, and a structure represented by general formula (11) below.

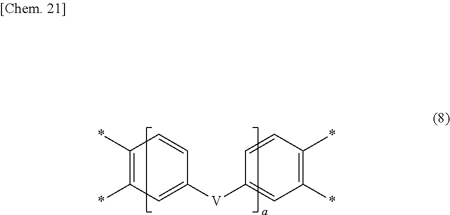

(In the formula, V represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, a fluorenylidene group, or a divalent group represented by general formula (9) below, a represents 0 or 1, and * represents a bonding position.)

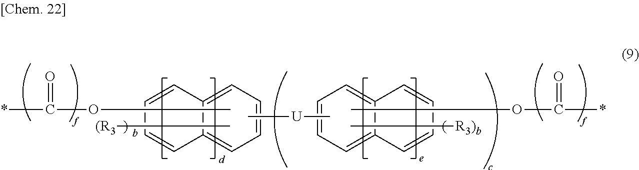

(In the formula, each R₃ independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom, U represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, or a fluorenylidene group, each b independently represents 0 or an integer of 1 to 4, c, d, e, and f each independently represent 0 or 1, and * represents a bonding position.)

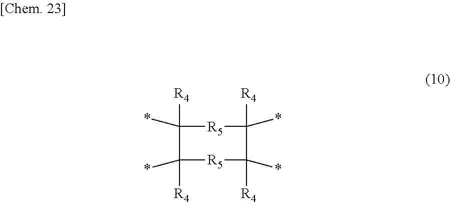

(In the formula, each R₄ independently represents a hydrogen atom or a methyl group, each R₅ independently represents a direct bond or an alkylene group having 1 to 3 carbon atoms, and * represents a bonding position.)

R₅ in general formula (10) is preferably a direct bond.

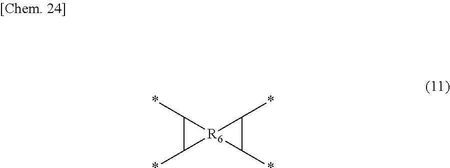

(In the formula, R₆ represents a tetravalent aliphatic group that optionally includes a double bond or a carbonyl group, and * represents a bonding position.)

The tetravalent aliphatic group that optionally includes a double bond or a carbonyl group in general formula (11) is preferably a tetravalent aliphatic group having 3 to 20 carbon atoms that optionally includes a double bond or a carbonyl group. Specific examples include groups represented by the following structural formulae.

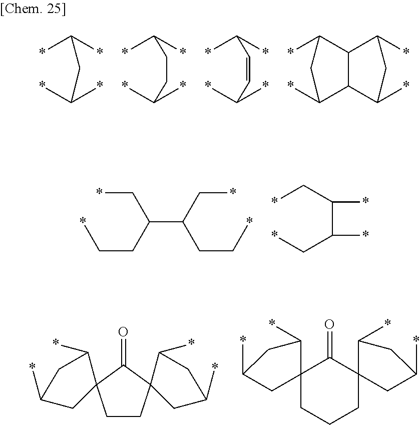

(In the formulae, * represents a bonding position.)

When the polyimide according to the present invention has a repeating unit other than the repeating unit represented by general formula (1), the content of the repeating unit represented by general formula (1) is preferably 15 mol % or more, more preferably 50 mol % or more, still more preferably 70 mol % or more, particularly preferably 90 mol % or more of the total amount of the polyimide. The repeating unit of general formula (1) above may be regularly arranged or randomly present in the polyimide.

Also when the repeating unit represented by general formula (1) is particularly the repeating unit represented by general formula (2), (3), or (4), its content is in the same mol % range, and when two or more repeating units selected from the repeating units represented by general formulae (2), (3), and (4) are contained, their total content is in the same mol % range.

The polyimide according to the present invention has a glass transition temperature of 210° C. or higher as determined by thermomechanical analysis, and sufficiently has heat resistance required for polyimide resins. This glass transition temperature is preferably 220° C. or higher, more preferably 230° C. or higher, particularly preferably 240° C. or higher.

The polyimide according to the present invention preferably has a thermal decomposition temperature (Td) of 350° C. or higher at which the residual weight percentage based on the weight at 100° C. in thermogravimetric analysis reaches 95%. The thermal decomposition temperature is more preferably 370° C. or higher, still more preferably 390° C. or higher, particularly preferably 400° C. or higher.

The method of producing the polyimide according to the present invention is not particularly limited. For example, the polyimide can be produced through a step of reacting a tetracarboxylic dianhydride represented by general formula (12) below and a diamine compound represented by general formula (13) below such that the amounts of the substances are equimolar to obtain a polyimide precursor (polyamic acid) represented by general formula (14) below and a step of imidizing the polyimide precursor.

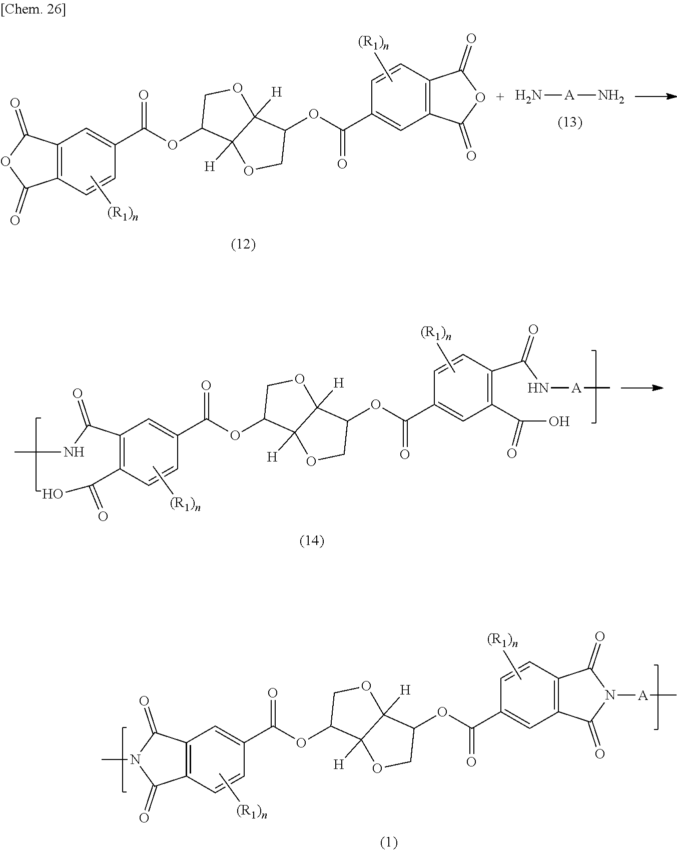

(R₁ and n in general formula (12) and general formula (14) and A in general formula (13) and general formula (14) are as defined in general formula (1).)

As a specific example of the method, a production method in the case where the tetracarboxylic dianhydride represented by general formula (12) above is isosorbide-bis(trimellitate anhydride) (compound (a)) and the diamine compound represented by general formula (13) above is 1,4-diaminocyclohexane (compound (b)) is shown by the following reaction formula. Compound (a) and compound (b) are polymerized to obtain a polyimide precursor (polyamic acid) (compound (c)) having the following repeating unit, and compound (c) is imidized, whereby a target polyimide (compound d) having the following repeating unit can be obtained.

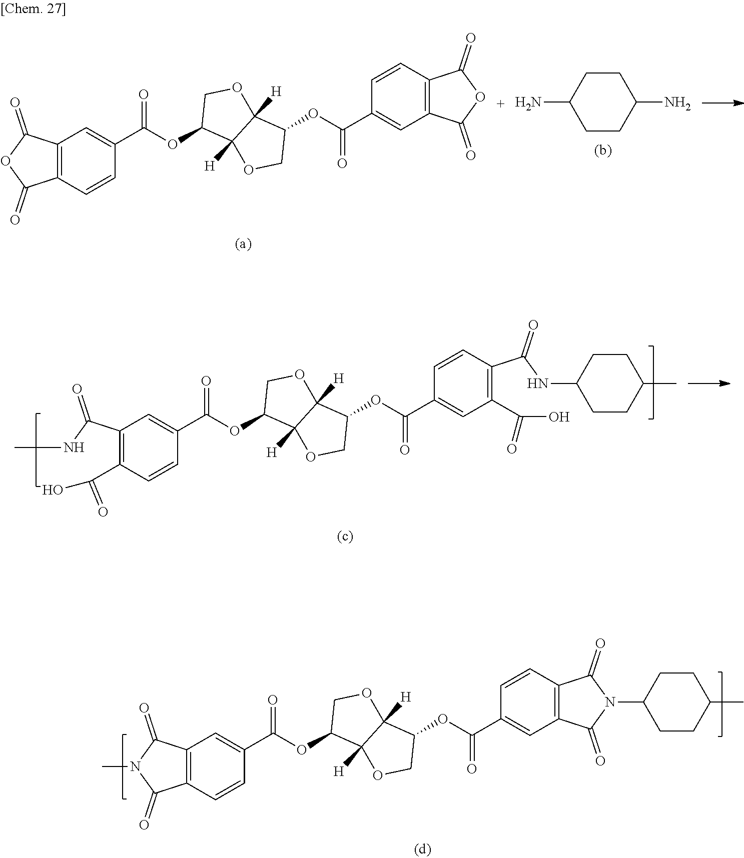

The tetracarboxylic dianhydride represented by general formula (12) can be produced by a method known in the art, and the production method is not limited. For example, the tetracarboxylic dianhydride can be produced by reacting a dianhydrohexitol such as isosorbide, isomannide, or isoidide and a trimellitic anhydride represented by general formula (15) such as trimellitic anhydride chloride, as represented by the following reaction formula.

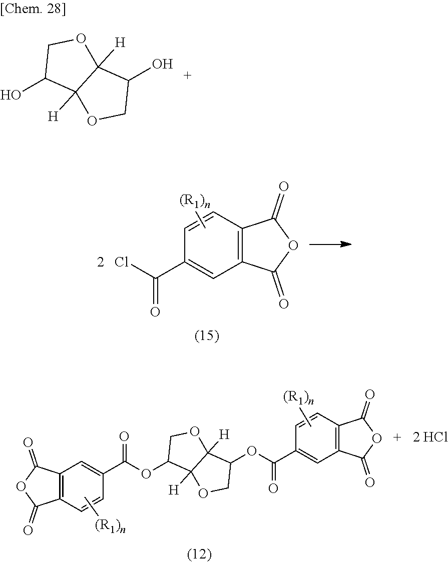

(R₁ and n in general formulae (15) and (12) are as defined in general formula (1).)

R₁ and n in general formula (12) are as defined in general formula (1), and preferred forms are also the same.

Specific examples of the tetracarboxylic dianhydride represented by general formula (12) include compounds represented by formulae (i) to (iii) below.

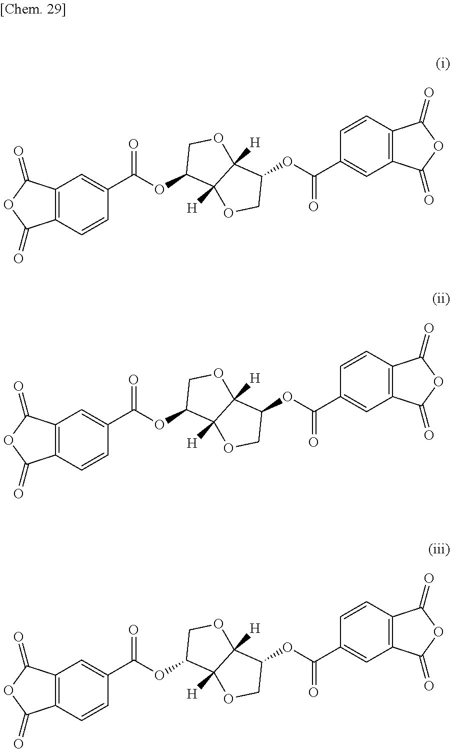

The compound represented by formula (i) is isosorbide-bis(trimellitate anhydride), the compound represented by formula (ii) is isoidide-bis(trimellitate anhydride), and the compound represented by formula (iii) is isomannide-bis(trimellitate anhydride). Hereinafter, these compounds are also referred to respectively as compound (i), compound (ii), and compound (iii).

Of these, the compound represented by formula (i) is particularly preferred.

In the method of producing the polyimide according to the present invention, one tetracarboxylic dianhydride represented by general formula (12) may be used alone, or two or more such tetracarboxylic dianhydrides may be used in combination.

A in general formula (13) is as defined in general formula (1), and preferred forms are also the same.

Specific examples of the diamine diamine compound in the case where A in general formula (13) is a divalent group represented by general formula (5) include, when p in general formula (5) is 0, diaminobenzenes such as p-phenylenediamine (PPD), m-phenylenediamine (MPD), 2,4-diaminotoluene, 2,5-diaminotoluene, 2,4-diaminoxylene, 1,4-diaminodurene, 1,4-diamino-2-phenylbenzene, 1,3-diamino-4-phenylbenzene, 1,3-diamino-5-phenylbenzene, 5-trifluoromethyl-1,3-phenylenediamine (TFMPD); and diaminonaphthalenes such as 1,4-diaminonaphthalene, 1,5-diaminonaphthalene, 2,6-diaminonaphthalene, and 2,7-diaminonaphthalene.

Of these, m-phenylenediamine (MPD), 2,4-diaminotoluene, 2,4-diaminoxylene, 1,3-diamino-4-phenylbenzene, 1,3-diamino-5-phenylbenzene, 5-trifluoromethyl-1,3-phenylenediamine (TFMPD), and the like are preferred, and m-phenylenediamine (MPD) and 5-trifluoromethyl-1,3-phenylenediamine (TEMPD) are more preferred.

When p in general formula (5) is 1, examples include diaminobiphenyls such as 2,2′-diaminobiphenyl, 3,3′-diaminobiphenyl, 4,4′-diaminobiphenyl, 2,2′-dimethyl-4,4′-diaminobiphenyl, and 2,2′-ditrifluoromethyl-4,4′-diaminobiphenyl (2,2′-bis(trifluoromethyl)benzidine; TFDB); diaminodiphenyl ethers such as 3,3′-diaminodiphenyl ether, 3,4′-diaminodiphenyl ether, and 4,4′-diaminodiphenyl ether; diaminodiphenyl sulfides such as 3,3′-diaminodiphenyl sulfide, 3,4′-diaminodiphenyl sulfide, and 4,4′-diaminodiphenyl sulfide; diaminodiphenyl sulfones such as 3,3′-diaminodiphenyl sulfone, 3,4′-diaminodiphenyl sulfone, and 4,4′-diaminodiphenyl sulfone; diaminobenzophenones such as 3,3′-diaminobenzophenone, 3,4′-diaminobenzophenone, and 4,4′-diaminobenzophenone; bis(aminophenyl)alkanes such as bis(3-aminophenyl) methane, bis(4-aminophenyl) methane, and 2,2-bis(4-aminophenyl) propane; bisaminophenylhexafluoropropanes such as 2,2-bis(3-aminophenyl)-1, 1, 1, 3, 3,3-hexafluoropropane and 2,2-bis(4-aminophenyl)-1, 1, 1, 3, 3,3-hexafluoropropane; bis(aminophenyl) cycloalkanes such as 1,1-bis(4-aminophenyl)cyclohexane; diaminoterphenyls such as 4,4″-diamino-p-terphenyl and 4,4″-diamino-m-terphenyl; and bis(aminophenyl) fluorenes such as 9,9-bis(4-aminophenyl) fluorene and 9,9-bis(4-amino-3-fluorophenyl) fluorene.

Among the diamine compounds represented by general formula (13), 2,2′-bis(trifluoromethyl) benzidine (TFDB) and 5-trifluoromethyl-1,3-phenylenediamine (TFMPD) are preferred.

Specific examples of the diamine compound represented by general formula (13) in the case where A in general formula (13) is a divalent organic group including a cyclic aliphatic group having 1 to 30 carbon atoms include 4,4′-methylenebis(cyclohexylamine), trans-1,4-diaminocyclohexane, cis-1,4-diaminocyclohexane, 1,4-cyclohexanebis(methylamine), 2,5-bis(aminomethyl) bicyclo[2.2.1]heptane, 2,6-bis(aminomethyl) bicyclo[2.2.1]heptane, bicyclo[2.2.2]octane-1,4-diamine, decahydro-1,4-naphthalenediamine, 3,8-bis(aminomethyl) tricyclo[5.2.1.0]decane, 1,3-diaminoadamantane, 2,2-bis(4-aminocyclohexyl) propane, and 2,2-bis(4-aminocyclohexyl) hexafluoropropane. Of these, trans-1,4-diaminocyclohexane and cis-1,4-diaminocyclohexane are preferred.

One diamine compound represented by general formula (13) may be used alone, or two or more such diamine compounds may be used in combination.

The polyimide in the case where the polyimide according to the present invention further has a repeating unit represented by general formula (6) can be produced by using, in addition to the tetracarboxylic dianhydride represented by general formula (12), an acid dianhydride used as a monomer for polyimide other than the tetracarboxylic dianhydride represented by general formula (12).

The tetracarboxylic dianhydride used as a monomer for polyimide other than the tetracarboxylic dianhydride represented by general formula (12) is preferably a tetracarboxylic dianhydride represented by any of general formulae (16) to (18) given later.

The tetracarboxylic dianhydride represented by general formula (16) is a compound represented by the following structural formula.

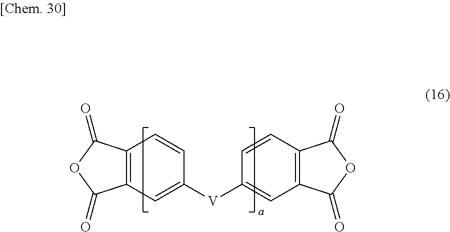

(In the formula, V and a are as defined in general formula (8).)

When a is 0, this tetracarboxylic dianhydride is specifically pyromellitic dianhydride. When a is 1, specific examples thereof include 3,3′,4,4′-biphenyltetracarboxylic dianhydride, 4,4′-oxydiphthalic anhydride, 3,3′,4,4′-diphenyl sulfide tetracarboxylic dianhydride, 3,3′,4,4′-diphenyl sulfone tetracarboxylic dianhydride, 3,3′,4,4′-benzophenone tetracarboxylic dianhydride, 4,4′-(hexafluoroisopropylidene) bis(phthalic) dianhydride, 1,4-bis(3,4-dicarboxyphenoxy)benzene dianhydride, 1,3-bis(3,4-dicarboxyphenoxy)benzene dianhydride, 4,4′-bis(3,4-dicarboxyphenoxy) biphenyl dianhydride, 4,4′-bis(3,4-dicarboxyphenoxy)-3,3′-dimethylbiphenyl dianhydride, bis[4-(3,4-dicarboxyphenoxy)phenyl] ether dianhydride, bis[4-(3,4-dicarboxyphenoxy)phenyl]sulfone dianhydride, 2,2-bis[4-(3,4-dicarboxyphenoxy)phenyl]propane dianhydride, 2,2-bis[4-(3,4-dicarboxyphenoxy)phenyl]hexafluoropropane dianhydride, 1,1-bis[4-(3,4-dicarboxyphenoxy)phenyl]cyclohexane dianhydride, 1,1-bis[4-(3,4-dicarboxyphenoxy)phenyl]cyclodecane dianhydride, 1,1-bis[4-(3,4-dicarboxyphenoxy)phenyl]-3, 3,5-trimethylcyclohexane dianhydride, 9,9-bis[4-(3,4-dicarboxyphenoxy)-3-methylphenyl]fluorene dianhydride, hydroquinone-bis(trimellitate anhydride), resorcinol-bis(trimellitate anhydride), 1,5-dihydroxynaphthalene-bis(trimellitate anhydride), 2,6-dihydroxynaphthalene-bis(trimellitate anhydride), 2,7-dihydroxynaphthalene-bis(trimellitate anhydride), 4,4′-dihydroxybiphenyl-bis(trimellitate anhydride), 4,4′-dihydroxy-3,3′-dimethylbiphenyl-bis(trimellitate anhydride), 4,4′-dihydroxy-3, 3′,5,5′-tetramethylbiphenyl-bis(trimellitate anhydride), 4,4′-dihydroxy-2, 2′,3, 3′,5,5′-hexamethylbiphenyl-bis(trimellitate anhydride), 4,4′-dihydroxydiphenyl ether-bis(trimellitate anhydride), 4,4′-dihydroxydiphenyl sulfide-bis(trimellitate anhydride), 4,4′-dihydroxydiphenyl sulfone-bis(trimellitate anhydride), 4,4′-dihydroxybenzophenone-bis(trimellitate anhydride), 1,1′-bis(4-hydroxyphenyl) ethane-bis(trimellitate anhydride), 2,2′-bis(4-hydroxyphenyl) propane-bis(trimellitate anhydride), 2,2′-bis(4-hydroxy-3-methylphenyl) propane-bis(trimellitate anhydride), 2,2′-bis(4-hydroxyphenyl) hexafluoropropane-bis(trimellitate anhydride), 1,1′-bis(4-hydroxyphenyl)cyclohexane-bis(trimellitate anhydride), 1,1′-bis(4-hydroxyphenyl)-3, 3,5-trimethylcyclohexane-bis(trimellitate anhydride), 1,1′-bis(4-hydroxyphenyl)cyclodecane-bis(trimellitate anhydride), and 9,9′-bis(4-hydroxy-3-methylphenyl) fluorene-bis(trimellitate anhydride).

The tetracarboxylic dianhydride represented by general formula (17) is a compound represented by the following structural formula.

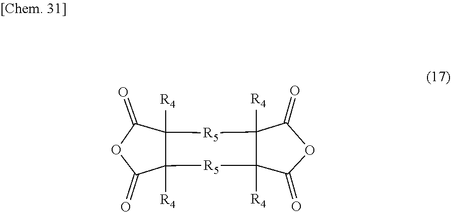

(In the formula, R₄ and R₅ are as defined in general formula (10).)

When R₅ is a direct bond, specific examples of the tetracarboxylic dianhydride represented by general formula (17) include cyclobutane-1,2, 3,4-tetracarboxylic dianhydride, 1,3-dimethylcyclobutane-1, 2, 3, 4-tetracarboxylic dianhydride, and 1,2, 3,4-tetramethylcyclobutane-1, 2, 3, 4-tetracarboxylic dianhydride. When one R₅ is a direct bond and the other is an alkylene group having 1 to 3 carbon atoms, specific examples thereof include cyclopentane-1, 2, 3, 4-tetracarboxylic dianhydride and cyclohexane-1, 2, 3, 4-tetracarboxylic dianhydride. When R₅ is an alkylene group having 1 to 3 carbon atoms, specific examples thereof include cyclohexane-1, 2, 4,5-tetracarboxylic dianhydride.

Of these, cyclobutane-1, 2, 3, 4-tetracarboxylic dianhydride, 1,3-dimethylcyclobutane-1, 2, 3, 4-tetracarboxylic dianhydride, and 1,2, 3,4-tetramethylcyclobutane-1, 2, 3, 4-tetracarboxylic dianhydride, in which R₅ is a direct bond, are preferred.

The tetracarboxylic dianhydride represented by general formula (18) is a compound represented by the following structural formula.

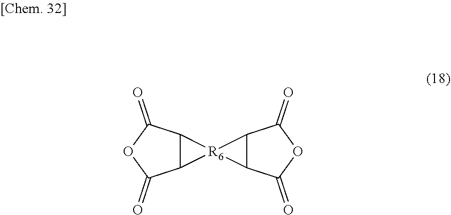

(In the formula, R₆ is as defined in general formula (11).)

Specific examples of the tetracarboxylic dianhydride represented by general formula (18) include compounds represented by the following structural formulae, and these forms are preferred.

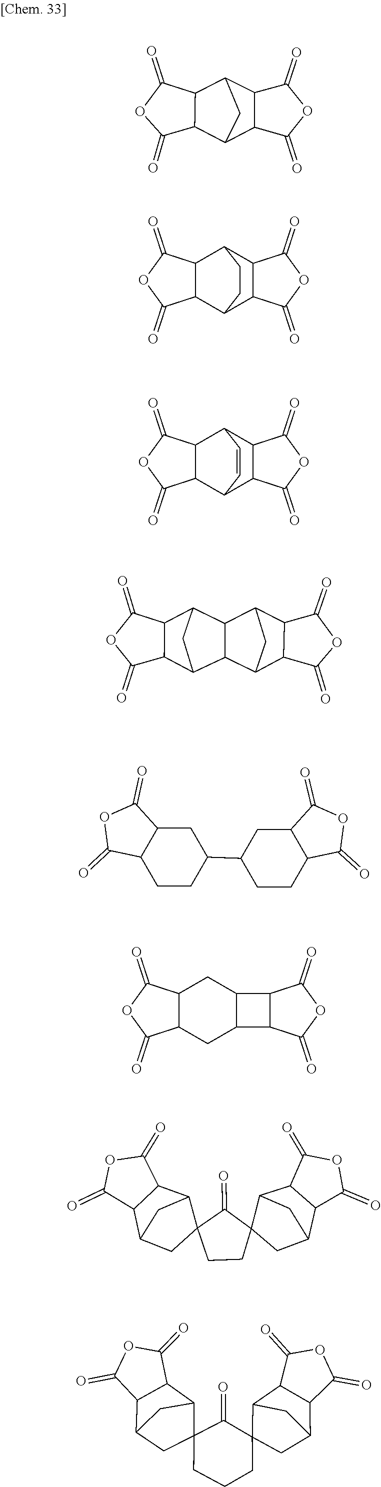

One tetracarboxylic dianhydride used as a monomer for polyimide other than the tetracarboxylic dianhydride represented by general formula (12) may be used alone, or two or more such tetracarboxylic dianhydrides may be used in combination.

In another embodiment, the polyimide according to the present invention has a repeating unit represented by general formula (1) below and has a thermal decomposition temperature (Td) of 350° C. or higher at which the residual weight percentage based on the weight at 100° C. in thermogravimetric analysis reaches 95%.

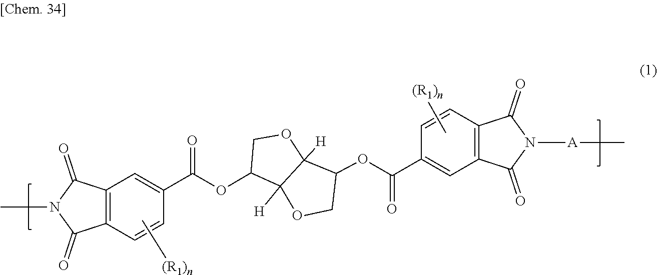

(In the formula, each R₁ independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom, each n independently represents 0 or an integer of 1 to 3, and A represents a divalent organic group.)

The polyimide according to the present invention preferably has one or more repeating units selected from repeating units represented by general formulae (2) to (4) below.

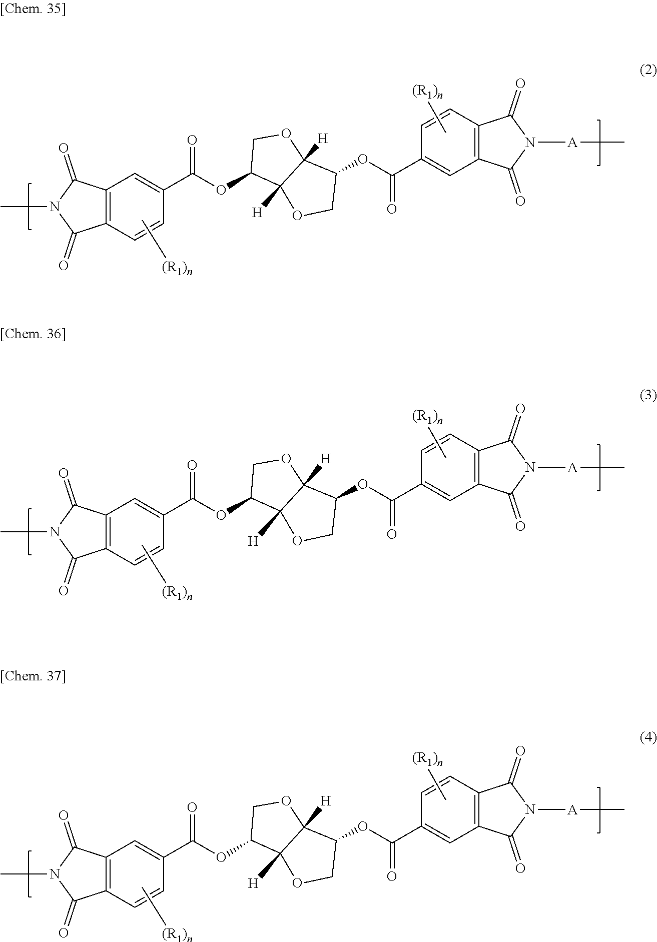

(R₁, n, and A in general formulae (2) to (4) are as defined in general formula (1).)

Of these, the polyimide particularly preferably has the repeating unit represented by general formula (2).

Examples of cases where the polyimide has two or more repeating units selected from the repeating units represented by general formulae (2) to (4) include the case where the polyimide has the repeating units represented by general formula (2) and general formula (3), the case where the polyimide has the repeating units represented by general formula (2) and general formula (4), the case where the polyimide has the repeating units represented by general formula (3) and general formula (4), and the case where the polyimide has the repeating units represented by general formula (2), general formula (3), and general formula (4).

Of these, the polyimide obtained when having the repeating units represented by general formula (2) and general formula (4) is preferred from the viewpoint of high light transmission properties and a decrease in birefringence (Δn). In this case, the molar ratio between the repeating unit represented by general formula (2) and the repeating unit represented by general formula (4) is preferably in the range of (2):(4)=99:1 to 50:50, more preferably in the range of (2):(4)=90:10 to 60:40, still more preferably in the range of (2):(4)=80:20 to 60:40.

Each R₁ in general formulae (1) to (4) independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom.

In particular, R₁ is preferably a linear or branched alkyl group having 1 to 4 carbon atoms, a linear or branched alkyl halide group having 1 to 4 carbon atoms, or a halogen atom, more preferably a linear or branched alkyl halide group having 1 to 4 carbon atoms or a halogen atom, particularly preferably a trifluoromethyl group or a fluorine atom.

Each n in general formulae (1) to (4) independently represents 0 or an integer of 1 to 3. In particular, n is preferably 0, 1, or 2, more preferably 0 or 1, particularly preferably 0.

A in general formulae (1) to (4) represents a divalent organic group. Preferably, A is a divalent organic group including an aromatic ring, or a divalent organic group including a linear, branched, or cyclic aliphatic group.

The divalent organic group including an aromatic ring is preferably a divalent organic group including an aromatic ring having 6 to 8 carbon atoms.

The divalent organic group including an aromatic ring is more preferably a divalent group represented by general formula (5) below.

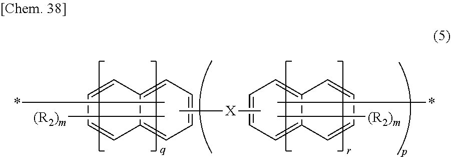

(In the formula, each R₂ independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom, each m independently represents 0 or an integer of 1 to 4, p, q, and r represent 0 or 1, X represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, or a fluorenylidene group, and each * represents a bonding position.)

Each R₂ in general formula (5) above independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom.

In particular, R₂ is preferably a linear or branched alkyl group having 1 to 4 carbon atoms, a linear or branched alkyl halide group having 1 to 4 carbon atoms, or a halogen atom, more preferably a linear or branched alkyl halide group having 1 to 4 carbon atoms or a halogen atom, still more preferably a linear or branched alkyl halide group having 1 to 4 carbon atoms, particularly preferably a trifluoromethyl group.

When R₂ in general formula (5) is an alkyl halide group such as a trifluoromethyl group, the charge-transfer properties in an electronic state formed by the moiety derived from a diamine compound and the moiety derived from trimellitic acid of a tetracarboxylic dianhydride in the ground state decrease, and the light absorption edge shifts from the visible range to the ultraviolet range, which is advantageous in that a polyimide having high light transmission properties in the visible range and also having a low refractive index, a small dielectric constant, and a small dielectric loss tangent is obtained. Here, the light absorption edge refers to a wavelength at which the absorbance steeply increases in an ultraviolet-visible light transmittance spectrum of a polyimide thin film.

Each m in general formula (5) independently represents 0 or an integer of 1 to 4, and is preferably 0, 1, or 2, more preferably 0 or 1.

p in general formula (5) represents 0 or 1, and is preferably 1. When p in general formula (5) is 0, two bonding positions are present on the aromatic ring on the left side in general formula (5). In this case, general formula (5) is represented as general formula (5′) below.

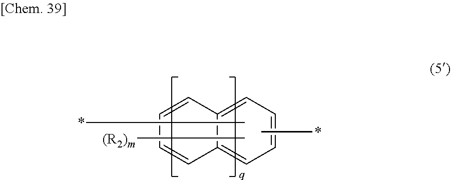

(In the formula, R₂, m, and q are as defined in general formula (5).)

q and r in general formula (5) each independently represent 0 or 1, preferably 0.

When p and q in general formula (5) are 0 (when q in general formula (5′) is 0), that is, when the aromatic ring in the formula is a benzene ring, the two bonding positions represented by * are preferably located in the para or meta positions of the benzene ring. In particular, when the two bonding positions are located in the meta positions, a bent structure of the m-phenylene bond reduces the electron-donating properties of the moiety derived from a diamine compound and inhibits intermolecular aggregation of a polyimide, so that the charge-transfer light absorption shifts to a shorter wavelength, which is advantageous in that a polyimide having high light transmission properties in the visible range and also having a low refractive index is obtained.

X in general formula (5) represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, or a fluorenylidene group. In particular, X is preferably a direct bond, an oxygen atom, a sulfur atom, a sulfonyl group (—SO₂—), a carbonyl group (—CO—), an amide group (—NHCO—), an ester group (—OCO—), an alkylidene group having 1 to 12 carbon atoms, a fluorine-containing alkylidene group having 2 to 12 carbon atoms, a cycloalkylidene group having 5 to 12 carbon atoms, a phenylethylidene group, or a fluorenylidene group, more preferably a direct bond, an oxygen atom, a sulfur atom, a sulfonyl group (—SO₂—), a carbonyl group (—CO—), an amide group (—NHCO—), an ester group (—OCO—), an alkylidene group having 1 to 8 carbon atoms, a fluorine-containing alkylidene group having 2 to 8 carbon atoms, a cycloalkylidene group having 6 to 12 carbon atoms, a phenylethylidene group, or a fluorenylidene group, particularly preferably a direct bond, an oxygen atom, a sulfur atom, a sulfonyl group (—SO₂—), an amide group (—NHCO—), an ester group (—OCO—), an alkylidene group having 1 to 4 carbon atoms, a fluorine-containing alkylidene group having 2 to 4 carbon atoms, a cycloalkylidene group having 6 to 9 carbon atoms, or a fluorenylidene group. The bonding positions of the amide group (—NHCO—) and the ester group (—OCO—) are not limited, and, for example, the amide group also includes “—CONH—”.

The cycloalkylidene group having 5 to 15 carbon atoms may include a branched-chain alkyl group. Specific examples of the cycloalkylidene group include a cyclopentylidene group (5 carbon atoms), a cyclohexylidene group (6 carbon atoms), a 3-methylcyclohexylidene group (7 carbon atoms), a 4-methylcyclohexylidene group (7 carbon atoms), a 3,3,5-trimethylcyclohexylidene group (9 carbon atoms), a cycloheptylidene group (7 carbon atoms), and a cyclododecanylidene group (12 carbon atoms).

The divalent organic group including a linear, branched, or cyclic aliphatic group is preferably a divalent organic group including a linear or branched aliphatic group having 1 to 30 carbon atoms or a cyclic aliphatic group having 4 to 30 carbon atoms. The divalent organic group is more preferably a hydrocarbon group including a linear or branched divalent aliphatic group having 2 to 20 carbon atoms or a cyclic divalent aliphatic group having 4 to 20 carbon atoms, and this hydrocarbon group may include a halogen atom such as a fluorine atom. The divalent organic group is still more preferably a linear or branched divalent aliphatic saturated hydrocarbon group having 2 to 20 carbon atoms or a cyclic divalent aliphatic saturated hydrocarbon group having 4 to 20 carbon atoms, particularly preferably a linear or branched divalent aliphatic hydrocarbon group having 6 to 20 carbon atoms or a cyclic divalent aliphatic hydrocarbon group having 6 to 20 carbon atoms, and these aliphatic hydrocarbon groups may include a halogen atom such as fluorine.

Specific examples of the divalent organic group including a linear, branched, or cyclic aliphatic group include a methylene group, a 1,2-ethylene group, a 1,3-propylene group, a 1,4-tetramethylene group, a 1,5-pentamethylene group, a 1,6-hexamethylene group, a 1,7-heptamethylene group, a 1,8-octamethylene group, a 1,9-nonamethylene group, a bis(1,4-cyclohexylene)methylene group, a trans-1,4-cyclohexane-diyl group, a cis-1, 4-cyclohexane-diyl group, a cyclohexane-1,4-bismethylene group, a bicyclo[2.2.1]heptane-2,5-bismethylene group, a bicyclo[2.2.1]heptane-2,6-bismethylene group, a bicyclo[2.2.2]octane-1,4-diyl group, a decahydronaphthalene-1,4-diyl group, a tricyclo[5.2.1.0]decane-3,8-bismethylene group, an adamantane-1,3-diyl group, an isopropylidenedicyclohexane-4,4′-diyl group, and a hexafluoroisopropylidenedicyclohexane-4,4′-diyl group.

Of these, in the case of a trans-1,4-cyclohexane-diyl group, a cis-1,4-cyclohexane-diyl group, a cyclohexane-1,4-bismethylene group, a bicyclo[2.2.1]heptane-2,5-bismethylene group, a bicyclo[2.2.1]heptane-2,6-bismethylene group, a bicyclo[2.2.2]octane-1,4-diyl group, a decahydronaphthalene-1,4-diyl group, a tricyclo[5.2.1.0]decane-3,8-bismethylene group, an adamantane-1,3-diyl group, an isopropylidenedicyclohexane-4,4′-diyl group, a hexafluoroisopropylidenedicyclohexane-4,4′-diyl group, and the like, each having an alicyclic skeleton, the charge-transfer properties in an electronic state formed by the moiety derived from a diamine compound and the moiety derived from trimellitic acid of a tetracarboxylic dianhydride in a polyimide in the ground state decrease, and the light absorption edge shifts from the visible range to the ultraviolet range, which is advantageous in that a polyimide having high light transmission properties in the visible range and also having a low refractive index is obtained. Of these, a trans-1,4-cyclohexane-diyl group and a cis-1,4-cyclohexane-diyl group are more preferred.

The polyimide according to the present invention, if containing the repeating unit represented by general formula (1) above, may have another skeleton as long as the advantageous effects of the present invention are not impaired.

For example, the polyimide may have a repeating unit represented by general formula (6) below.

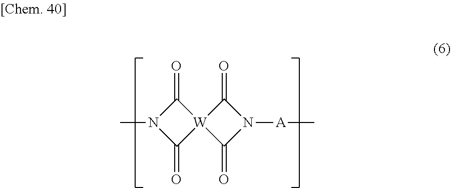

(In the formula, W represents a tetravalent organic group (excluding the tetravalent group represented by general formula (7) below), and A is as defined in general formula (1).)

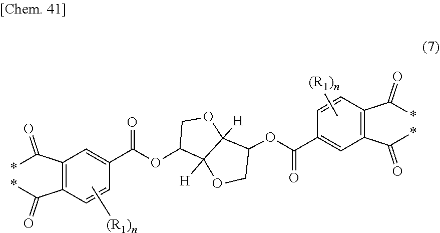

(In the formula, R₁ and n are as defined in general formula (1), and * represents a bonding position.)

The tetravalent organic group represented by W in the repeating unit represented by general formula (6) is preferably any one or more of a structure represented by general formula (8) below, a structure represented by general formula (10) below, and a structure represented by general formula (11) below.

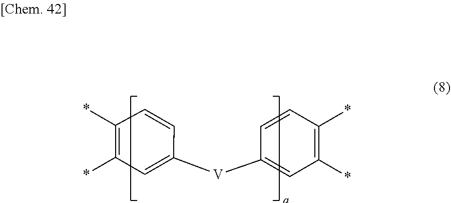

(In the formula, V represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, a fluorenylidene group, or a divalent group represented by general formula (9) below, a represents 0 or 1, and * represents a bonding position.)

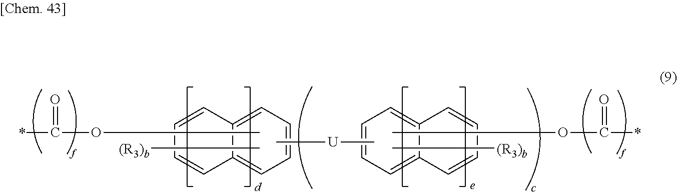

(In the formula, each R₃ independently represents a linear or branched alkyl group having 1 to 6 carbon atoms, a cyclic alkyl group having 5 or 6 carbon atoms, a linear or branched alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a linear or branched alkyl halide group having 1 to 6 carbon atoms, or a halogen atom, U represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, or a fluorenylidene group, each b independently represents 0 or an integer of 1 to 4, c, d, e, and f each independently represent 0 or 1, and * represents a bonding position.)

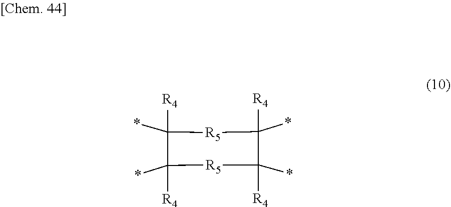

(In the formula, each R₄ independently represents a hydrogen atom or a methyl group, each R₅ independently represents a direct bond or an alkylene group having 1 to 3 carbon atoms, and * represents a bonding position.)

R₅ in general formula (10) is preferably a direct bond.

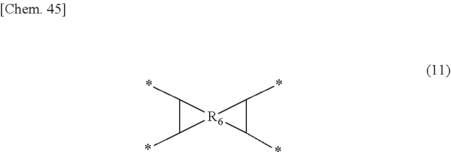

(In the formula, R₆ represents a tetravalent aliphatic group that optionally includes a double bond or a carbonyl group, and * represents a bonding position.)

The tetravalent aliphatic group that optionally includes a double bond or a carbonyl group in general formula (11) is preferably a tetravalent aliphatic group having 3 to 20 carbon atoms that optionally includes a double bond or a carbonyl group. Specific examples include groups represented by the following structural formulae.

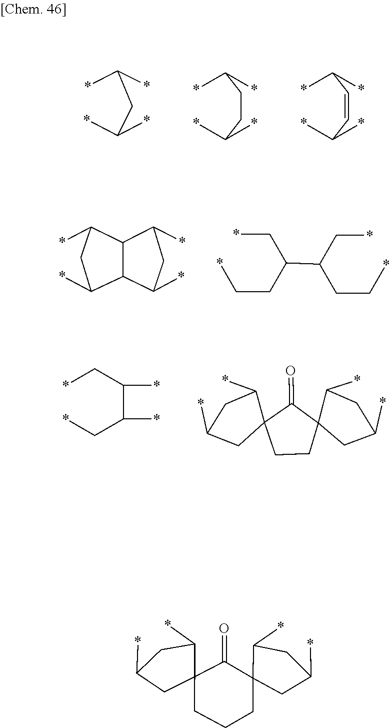

(In the formulae, * represents a bonding position.)

When the polyimide according to the present invention has a repeating unit other than the repeating unit represented by general formula (1), the content of the repeating unit represented by general formula (1) is preferably 15 mol % or more, more preferably 50 mol % or more, still more preferably 70 mol % or more, particularly preferably 90 mol % or more of the total amount of the polyimide. The repeating unit of general formula (1) above may be regularly arranged or randomly present in the polyimide.

Also when the repeating unit represented by general formula (1) is particularly the repeating unit represented by general formula (2), (3), or (4), its content is in the same mol % range, and when two or more repeating units selected from the repeating units represented by general formulae (2), (3), and (4) are contained, their total content is in the same mol % range.

The polyimide according to the present invention has a thermal decomposition temperature (Td) of 350° C. or higher at which the residual weight percentage based on the weight at 100° C. in thermogravimetric analysis reaches 95%, and thus has high thermal stability and sufficiently has heat resistance required for polyimide resins. This thermal decomposition temperature is preferably 370° C. or higher, more preferably 380° C. or higher, still more preferably 390° C. or higher, particularly preferably 400° C. or higher.

The method of producing the polyimide according to the present invention is not particularly limited. For example, the polyimide can be produced through a step of reacting a tetracarboxylic dianhydride represented by general formula (12) below and a diamine compound represented by general formula (13) below such that the amounts of the substances are equimolar to obtain a polyimide precursor (polyamic acid) represented by general formula (14) below and a step of imidizing the polyimide precursor.

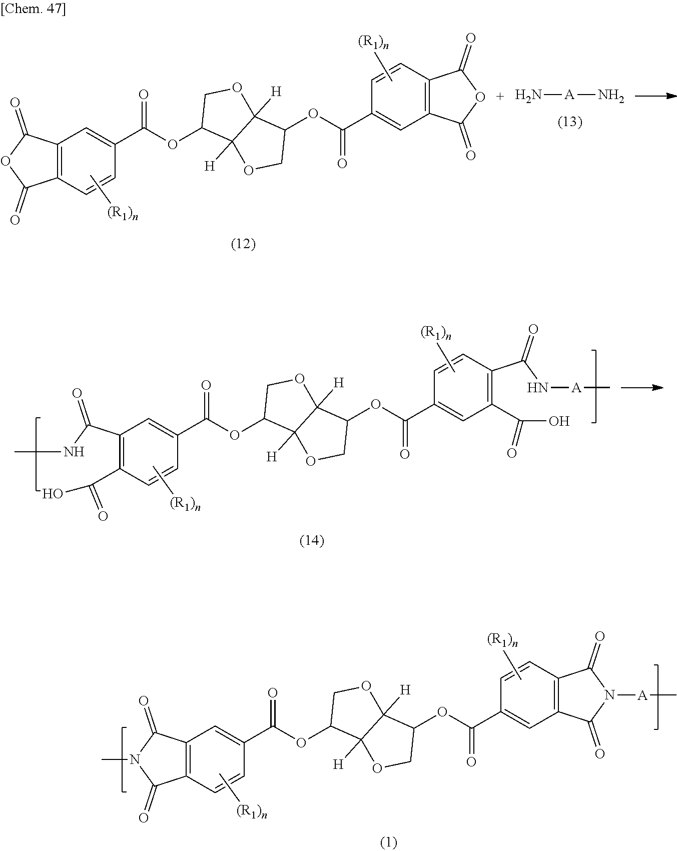

(R₁ and n in general formula (12) and general formula (14) and A in general formula (13) and general formula (14) are as defined in general formula (1).)

As a specific example of the method, a production method in the case where the tetracarboxylic dianhydride represented by general formula (12) above is isosorbide-bis(trimellitate anhydride) (compound (a)) and the diamine compound represented by general formula (13) above is 1,4-diaminocyclohexane (compound (b)) is shown by the following reaction formula. Compound (a) and compound (b) are polymerized to obtain a polyimide precursor (polyamic acid) (compound (c)) having the following repeating unit, and compound (c) is imidized, whereby a target polyimide (compound d) having the following repeating unit can be obtained.

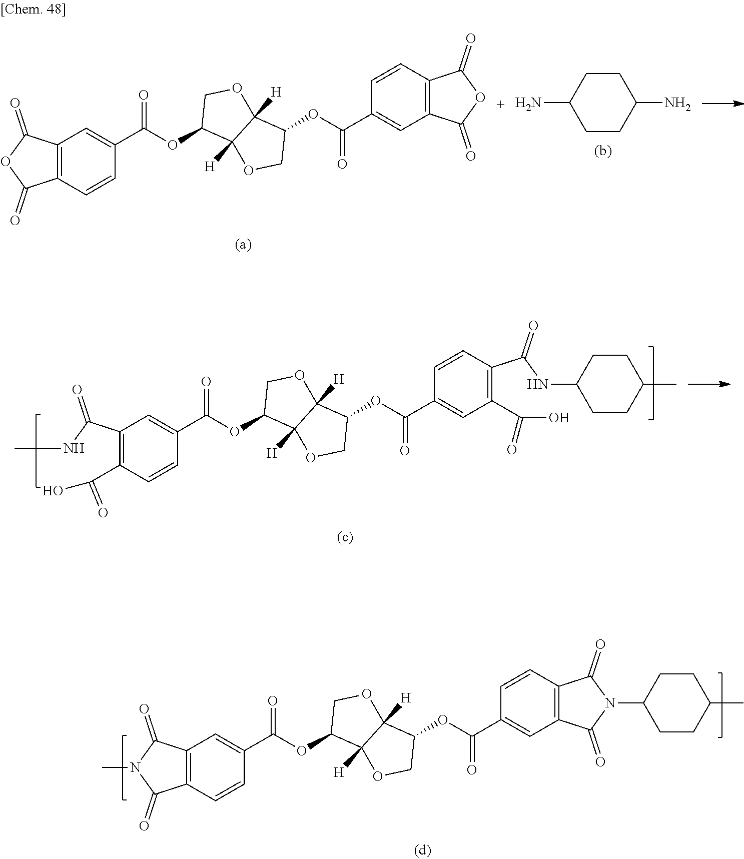

The tetracarboxylic dianhydride represented by general formula (12) can be produced by a method known in the art, and the production method is not limited. For example, the tetracarboxylic dianhydride can be produced by reacting a dianhydrohexitol such as isosorbide, isomannide, or isoidide and a trimellitic anhydride represented by general formula (15) such as trimellitic anhydride chloride, as represented by the following reaction formula.

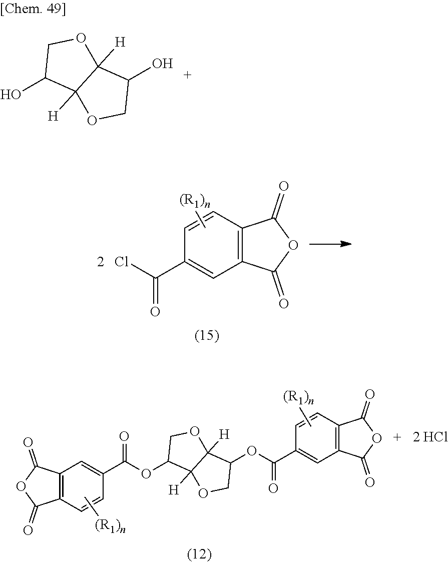

(R₁ and n in general formulae (15) and (12) are as defined in general formula (1).)

R₁ and n in general formula (12) are as defined in general formula (1), and preferred forms are also the same.

Specific examples of the tetracarboxylic dianhydride represented by general formula (12) include compounds represented by formulae (i) to (iii) below.

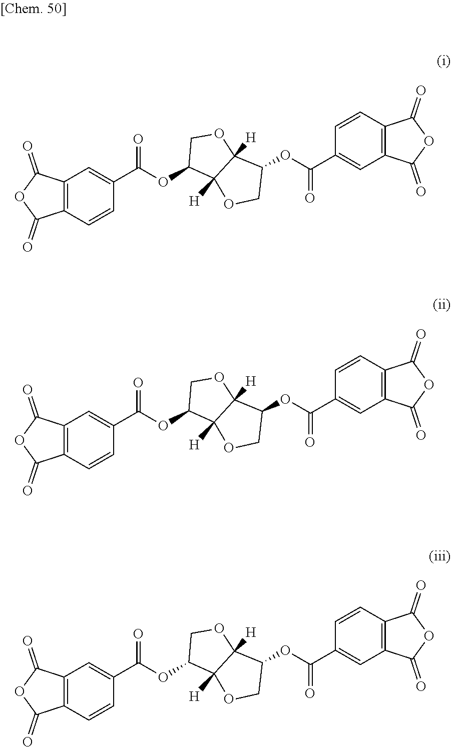

The compound represented by formula (i) is isosorbide-bis(trimellitate anhydride), the compound represented by formula (ii) is isoidide-bis(trimellitate anhydride), and the compound represented by formula (iii) is isomannide-bis(trimellitate anhydride). Hereinafter, these compounds are also referred to respectively as compound (i), compound (ii), and compound (iii).

Of these, the compound represented by formula (i) is particularly preferred.

In the method of producing the polyimide according to the present invention, one tetracarboxylic dianhydride represented by general formula (12) may be used alone, or two or more such tetracarboxylic dianhydrides may be used in combination.

A in general formula (13) is as defined in general formula (1), and preferred forms are also the same.

When A in general formula (13) is a divalent organic group including an aromatic ring, the diamine compound represented by general formula (13) is a diamine compound including an aromatic ring. The diamine compound including an aromatic ring preferably has a divalent group represented by general formula (5). Specific examples of the diamine diamine compound including an aromatic ring include, when p in general formula (5) is 0, diaminobenzenes such as p-phenylenediamine (PPD), m-phenylenediamine (MPD), 2,4-diaminotoluene, 2,5-diaminotoluene, 2,4-diaminoxylene, 1,4-diaminodurene, 1,4-diamino-2-phenylbenzene, 1,3-diamino-4-phenylbenzene, 1,3-diamino-5-phenylbenzene, 5-trifluoromethyl-1,3-phenylenediamine (TEMPD); and diaminonaphthalenes such as 1,4-diaminonaphthalene, 1,5-diaminonaphthalene, 2,6-diaminonaphthalene, and 2,7-diaminonaphthalene.

Of these, m-phenylenediamine (MPD), 2,4-diaminotoluene, 2,4-diaminoxylene, 1,3-diamino-4-phenylbenzene, 1,3-diamino-5-phenylbenzene, 5-trifluoromethyl-1,3-phenylenediamine (TEMPD), and the like are preferred, and m-phenylenediamine (MPD) and 5-trifluoromethyl-1,3-phenylenediamine (TFMPD) are more preferred.

When p in general formula (5) is 1, examples include diaminobiphenyls such as 2,2′-diaminobiphenyl, 3,3′-diaminobiphenyl, 4,4′-diaminobiphenyl, 2,2′-dimethyl-4,4′-diaminobiphenyl, and 2,2′-ditrifluoromethyl-4,4′-diaminobiphenyl (2,2′-bis(trifluoromethyl) benzidine; TFDB); diaminodiphenyl ethers such as 3,3′-diaminodiphenyl ether, 3,4′-diaminodiphenyl ether, and 4,4′-diaminodiphenyl ether; diaminodiphenyl sulfides such as 3,3′-diaminodiphenyl sulfide, 3,4′-diaminodiphenyl sulfide, and 4,4′-diaminodiphenyl sulfide; diaminodiphenyl sulfones such as 3,3′-diaminodiphenyl sulfone, 3,4′-diaminodiphenyl sulfone, and 4,4′-diaminodiphenyl sulfone; diaminobenzophenones such as 3,3′-diaminobenzophenone, 3,4′-diaminobenzophenone, and 4,4′-diaminobenzophenone; bis(aminophenyl) alkanes such as bis(3-aminophenyl) methane, bis(4-aminophenyl) methane, and 2,2-bis(4-aminophenyl) propane; bisaminophenylhexafluoropropanes such as 2,2-bis(3-aminophenyl)-1,1, 1, 3, 3,3-hexafluoropropane and 2,2-bis(4-aminophenyl)-1,1, 1, 3, 3,3-hexafluoropropane; bis(aminophenyl) cycloalkanes such as 1,1-bis(4-aminophenyl)cyclohexane; diaminoterphenyls such as 4,4″-diamino-p-terphenyl and 4,4″-diamino-m-terphenyl; and bis(aminophenyl) fluorenes such as 9,9-bis(4-aminophenyl) fluorene and 9,9-bis(4-amino-3-fluorophenyl) fluorene.

Among the diamine compounds represented by general formula (13), 2,2′-bis(trifluoromethyl) benzidine (TFDB) and 5-trifluoromethyl-1,3-phenylenediamine (TFMPD) are preferred.

When A in general formula (13) is a divalent organic group including a linear, branched, or cyclic aliphatic group, the diamine compound represented by general formula (13) is a diamine compound having the linear, branched, or cyclic aliphatic group. Specific examples of such diamine compounds include 1,2-ethylenediamine, 1,3-propanediamine, 1,4-tetramethylenediamine, 1,5-pentamethylenediamine, 1,6-hexamethylenediamine, 1,7-heptamethylenediamine, 1,8-octamethylenediamine, 1,9-nonamethylenediamine, 4,4′-methylenebis(cyclohexylamine), trans-1,4-diaminocyclohexane, cis-1,4-diaminocyclohexane, 1,4-cyclohexanebis(methylamine), 2,5-bis(aminomethyl) bicyclo[2.2.1]heptane, 2,6-bis(aminomethyl) bicyclo[2.2.1]heptane, bicyclo[2.2.2]octane-1,4-diamine, decahydro-1,4-naphthalenediamine, 3,8-bis(aminomethyl) tricyclo[5.2.1.0]decane, 1,3-diaminoadamantane, 2,2-bis(4-aminocyclohexyl) propane, and 2,2-bis(4-aminocyclohexyl) hexafluoropropane.

Of these, diamine compounds having an alicyclic skeleton, such as 4,4′-methylenebis(cyclohexylamine), trans-1,4-diaminocyclohexane, cis-1,4-diaminocyclohexane, 1,4-cyclohexanebis(methylamine), 2,5-bis(aminomethyl) bicyclo[2.2.1]heptane, 2,6-bis(aminomethyl) bicyclo[2.2.1]heptane, bicyclo[2.2.2]octane-1,4-diamine, decahydro-1,4-naphthalenediamine, 3,8-bis(aminomethyl) tricyclo[5.2.1.0]decane, 1,3-diaminoadamantane, 2,2-bis(4-aminocyclohexyl) propane, and 2,2-bis(4-aminocyclohexyl) hexafluoropropane, are preferred, and trans-1,4-diaminocyclohexane and cis-1,4-diaminocyclohexane are more preferred.

One diamine compound represented by general formula (13) may be used alone, or two or more such diamine compounds may be used in combination.

The polyimide in the case where the polyimide according to the present invention further has a repeating unit represented by general formula (6) can be produced by using, in addition to the tetracarboxylic dianhydride represented by general formula (12), an acid dianhydride used as a monomer for polyimide other than the tetracarboxylic dianhydride represented by general formula (12).

The tetracarboxylic dianhydride used as a monomer for polyimide other than the tetracarboxylic dianhydride represented by general formula (12) is preferably a tetracarboxylic dianhydride represented by any of general formulae (16) to (18) given later.

The tetracarboxylic dianhydride represented by general formula (16) is a compound represented by the following structural formula.

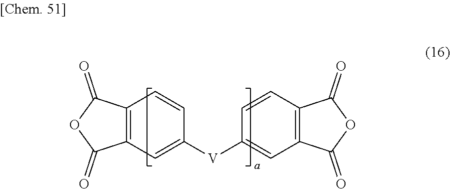

(In the formula, V and a are as defined in general formula (8).)

When a is 0, this tetracarboxylic dianhydride is specifically pyromellitic dianhydride. When a is 1, specific examples thereof include 3, 3′,4,4′-biphenyltetracarboxylic dianhydride, 4,4′-oxydiphthalic anhydride, 3, 3′,4,4′-diphenyl sulfide tetracarboxylic dianhydride, 3, 3′,4,4′-diphenyl sulfone tetracarboxylic dianhydride, 3, 3′,4,4′-benzophenone tetracarboxylic dianhydride, 4,4′-(hexafluoroisopropylidene) bis(phthalic) dianhydride, 1,4-bis(3,4-dicarboxyphenoxy)benzene dianhydride, 1,3-bis(3,4-dicarboxyphenoxy)benzene dianhydride, 4,4′-bis(3,4-dicarboxyphenoxy) biphenyl dianhydride, 4,4′-bis(3,4-dicarboxyphenoxy)-3,3′-dimethylbiphenyl dianhydride, bis[4-(3,4-dicarboxyphenoxy)phenyl] ether dianhydride, bis[4-(3,4-dicarboxyphenoxy)phenyl]sulfone dianhydride, 2,2-bis[4-(3,4-dicarboxyphenoxy)phenyl]propane dianhydride, 2,2-bis[4-(3,4-dicarboxyphenoxy)phenyl]hexafluoropropane dianhydride, 1,1-bis[4-(3,4-dicarboxyphenoxy)phenyl]cyclohexane dianhydride, 1,1-bis[4-(3,4-dicarboxyphenoxy)phenyl]cyclodecane dianhydride, 1,1-bis[4-(3,4-dicarboxyphenoxy)phenyl]-3, 3,5-trimethylcyclohexane dianhydride, 9,9-bis[4-(3,4-dicarboxyphenoxy)-3-methylphenyl]fluorene dianhydride, hydroquinone-bis(trimellitate anhydride), resorcinol-bis(trimellitate anhydride), 1,5-dihydroxynaphthalene-bis(trimellitate anhydride), 2,6-dihydroxynaphthalene-bis(trimellitate anhydride), 2,7-dihydroxynaphthalene-bis(trimellitate anhydride), 4,4′-dihydroxybiphenyl-bis(trimellitate anhydride), 4,4′-dihydroxy-3,3′-dimethylbiphenyl-bis(trimellitate anhydride), 4,4′-dihydroxy-3, 3′,5,5′-tetramethylbiphenyl-bis(trimellitate anhydride), 4,4′-dihydroxy-2, 2′,3, 3′,5,5′-hexamethylbiphenyl-bis(trimellitate anhydride), 4,4′-dihydroxydiphenyl ether-bis(trimellitate anhydride), 4,4′-dihydroxydiphenyl sulfide-bis(trimellitate anhydride), 4,4′-dihydroxydiphenyl sulfone-bis(trimellitate anhydride), 4,4′-dihydroxybenzophenone-bis(trimellitate anhydride), 1,1′-bis(4-hydroxyphenyl) ethane-bis(trimellitate anhydride), 2,2′-bis(4-hydroxyphenyl) propane-bis(trimellitate anhydride), 2,2′-bis(4-hydroxy-3-methylphenyl) propane-bis(trimellitate anhydride), 2,2′-bis(4-hydroxyphenyl) hexafluoropropane-bis(trimellitate anhydride), 1,1′-bis(4-hydroxyphenyl)cyclohexane-bis(trimellitate anhydride), 1,1′-bis(4-hydroxyphenyl)-3, 3,5-trimethylcyclohexane-bis(trimellitate anhydride), 1,1′-bis(4-hydroxyphenyl)cyclodecane-bis(trimellitate anhydride), and 9,9′-bis(4-hydroxy-3-methylphenyl) fluorene-bis(trimellitate anhydride).

The tetracarboxylic dianhydride represented by general formula (17) is a compound represented by the following structural formula.

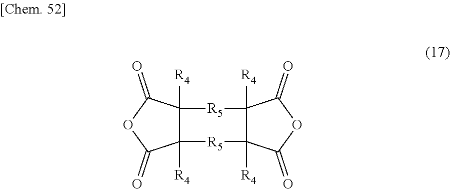

(In the formula, R₄ and R₅ are as defined in general formula (10).)

When R₅ is a direct bond, specific examples of the tetracarboxylic dianhydride represented by general formula (17) include cyclobutane-1, 2, 3, 4-tetracarboxylic dianhydride, 1,3-dimethylcyclobutane-1,2, 3,4-tetracarboxylic dianhydride, and 1,2, 3,4-tetramethylcyclobutane-1, 2, 3, 4-tetracarboxylic dianhydride. When one R₅ is a direct bond and the other is an alkylene group having 1 to 3 carbon atoms, specific examples thereof include cyclopentane-1, 2, 3, 4-tetracarboxylic dianhydride and cyclohexane-1, 2, 3, 4-tetracarboxylic dianhydride. When R₅ is an alkylene group having 1 to 3 carbon atoms, specific examples thereof include cyclohexane-1, 2, 4,5-tetracarboxylic dianhydride.

Of these, cyclobutane-1, 2, 3, 4-tetracarboxylic dianhydride, 1,3-dimethylcyclobutane-1, 2, 3, 4-tetracarboxylic dianhydride, and 1,2,3,4-tetramethylcyclobutane-1, 2, 3, 4-tetracarboxylic dianhydride, in which R₅ is a direct bond, are preferred.

The tetracarboxylic dianhydride represented by general formula (18) is a compound represented by the following structural formula.

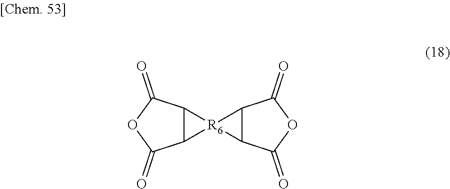

(In the formula, Re is as defined in general formula (11).)

Specific examples of the tetracarboxylic dianhydride represented by general formula (18) include compounds represented by the following structural formulae, and these forms are preferred.

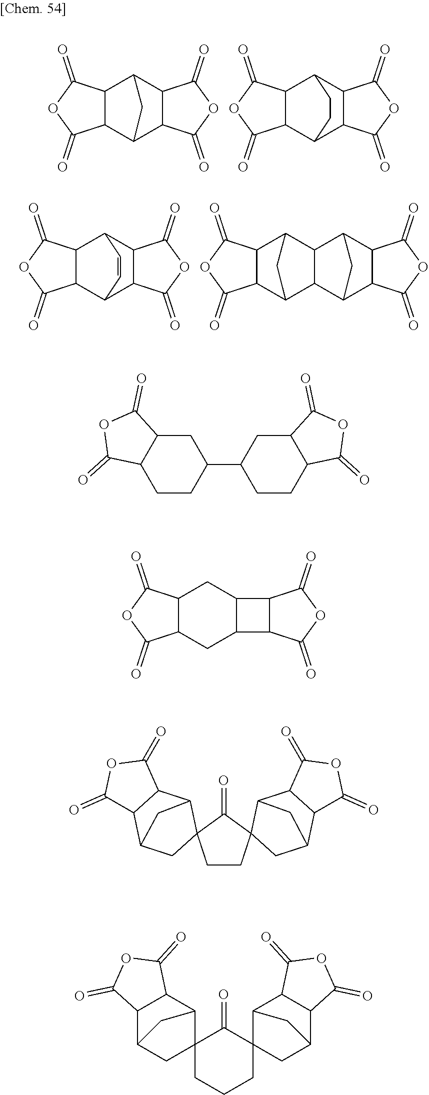

One tetracarboxylic dianhydride used as a monomer for polyimide other than the tetracarboxylic dianhydride represented by general formula (12) may be used alone, or two or more such tetracarboxylic dianhydrides may be used in combination.

In the production of the polyimide according to the present invention, the lower limit of the amount (total molar amount) of a diamine compound used relative to the total molar amount of a tetracarboxylic dianhydride compound taken as 1 mol is preferably 0.94 mol or more, more preferably 0.96 mol or more, still more preferably 0.98 mol or more, particularly preferably 0.99 mol or more, and the upper limit thereof is preferably 1.20 mol or less, more preferably 1.10 mol or less, still more preferably 1.05 mol or less, particularly preferably 1.02 mol or less.

A specific example of a method of polymerization reaction in producing the polyimide according to the present invention will be described.

First, a diamine compound is dissolved in a polymerization solvent, and a tetracarboxylic dianhydride is gradually added to the solution. Using a mechanical stirrer or the like, the resulting solution is stirred at a temperature in the range of 0° C. to 100° C., preferably 20° C. to 60° C., for 0.5 to 150 hours, preferably 1 to 72 hours. At this time, the monomer concentration is typically in the range of 5 to 50 wt %, preferably in the range of 10 to 40 wt %. By performing polymerization in such a monomer concentration range, a uniform and highly polymerized polyimide precursor (polyamic acid) can be obtained. If the degree of polymerization of the polyimide precursor (polyamic acid) is excessively increased to make it difficult to stir the polymer solution, the polymer solution may be appropriately diluted with the same solvent. By performing polymerization in the above monomer concentration range, the degree of polymerization of the polymer can be sufficiently high, and the solubility of the monomers and the polymer can be sufficiently secured. If the polymerization is performed at a concentration lower than the above range, the degree of polymerization of the polyimide precursor (polyamic acid) may be not sufficiently high, and if the polymerization is performed at a concentration higher than the above monomer concentration range, the dissolution of the monomers and the resulting polymer may be insufficient.

The solvent used for the polymerization of the polyimide precursor (polyamic acid) is preferably an aprotic solvent such as N, N-dimethylformamide, N, N-dimethylacetamide, N-methyl-2-pyrrolidone, or dimethylsulfoxide, but any solvent in which the starting monomers, the resulting polyimide precursor (polyamic acid), and an imidized polyimide are soluble can be used without any problem, and the structure and type of the solvent are not particularly limited. Specific examples include amide solvents such as N, N-dimethylformamide, N, N-dimethylacetamide, and N-methyl-2-pyrrolidone; ester solvents such as γ-butyrolactone, γ-valerolactone, δ-valerolactone, γ-caprolactone, ε-caprolactone, α-methyl-γ-butyrolactone, butyl acetate, ethyl acetate, and isobutyl acetate; carbonate solvents such as ethylene carbonate and propylene carbonate; glycol solvents such as diethylene glycol dimethyl ether, triethylene glycol, and triethylene glycol dimethyl ether; phenolic solvents such as phenol, m-cresol, p-cresol, o-cresol, 3-chlorophenol, and 4-chlorophenol; ketone solvents such as cyclopentanone, cyclohexanone, acetone, methyl ethyl ketone, diisobutyl ketone, and methyl isobutyl ketone; and ether solvents such as tetrahydrofuran, 1,4-dioxane, dimethoxyethane, diethoxyethane, and dibutyl ether. Other general-purpose solvents that can be used include acetophenone, 1,3-dimethyl-2-imidazolidinone, sulfolane, dimethylsulfoxide, propylene glycol methyl acetate, ethyl cellosolve, butyl cellosolve, 2-methyl cellosolve acetate, ethyl cellosolve acetate, butyl cellosolve acetate, butanol, ethanol, xylene, toluene, chlorobenzene, turpentine, mineral spirits, and petroleum naphtha solvents. These solvents may be used as a mixture of two or more.

In the polymerization reaction in producing the polyimide according to the present invention, a sililation reagent can be further used in order to reduce the likelihood of aggregation of the raw materials and insolubilization (gelation) of the product. Examples of sililation reagents that can be used include, but are not limited to, N, O-bis(trimethylsilyl) acetamide and N, O-bis(trimethylsilyl) trifluoroacetamide.

A method of imidizing the polyimide precursor (polyamic acid) obtained will be described.

For imidization, a known imidization method can be applied. For example, a “thermal imidization method” in which a polyimide precursor (polyamic acid) thin film is thermally cyclized, a “solution thermal imidization method” in which a polyimide precursor (polyamic acid) solution is cyclized at a high temperature, a “chemical imidization method” in which a dehydrator is used, or the like can be appropriately used.

Specifically, in the “thermal imidization method”, the polyimide precursor (polyamic acid) solution is cast on a substrate or the like and dried at 50° C. to 200° C., preferably 60° C. to 150° C., to form a polyimide precursor (polyamic acid) thin film, which is then heated in an inert gas or under reduced pressure at 150° C. to 400° C., preferably 200° C. to 380° C., for 1 to 12 hours to cause thermal dehydration cyclization and complete imidization, whereby the polyimide according to the present invention can be obtained.

In the “solution thermal imidization method”, the polyimide precursor (polyamic acid) solution to which a basic catalyst or the like has been added is heated in the presence of an azeotropic agent such as xylene at 100° C. to 250° C., preferably 150° C. to 220° C., for 0.5 to 12 hours to remove water produced as a by-product out of the system and complete imidization, whereby the polyimide according to the present invention solution can be obtained. Alternatively, the polyimide precursor (polyamic acid) solution is heated in an amide solvent such as N, N-dimethylacetamide, N-methyl-2-pyrrolidone, or 1,3-dimethyl-2-imidazolidinone under a stream of nitrogen at 150° C. to 220° C., preferably 165° C. to 205° C., for 0.5 to 2 hours to partially remove water produced as a by-product out of the system and complete imidization, whereby the polyimide according to the present invention solution can be obtained.

In the “chemical imidization method”, while the polyimide precursor (polyamic acid) solution adjusted to have an appropriate solution viscosity that allows the polyimide precursor (polyamic acid) to be easily stirred is stirred with a mechanical stirrer or the like, a dehydration cyclizing agent (chemical imidizing agent) composed of an organic acid anhydride and an amine as a basic catalyst is added dropwise, and stirring is performed at 0° C. to 100° C., preferably 10° C. to 50° C., for 1 to 72 hours to chemically complete imidization. Examples of organic acid anhydrides usable here include, but are not limited to, acetic anhydride and propionic anhydride. In terms of the ease of handling and purification of a reagent, acetic anhydride is suitable for use. As the basic catalyst, pyridine, triethylamine, quinoline, or the like can be used, and in terms of the ease of handling and separation of a reagent, pyridine is suitable for use, but the basic catalyst is not limited thereto. The amount of the organic acid anhydride in the chemical imidizing agent is in the range of 1 to 10 times, more preferably 1 to 5 times, the theoretical dehydration amount of the polyimide precursor (polyamic acid) on a molar basis. The amount of the basic catalyst is in the range of 0.1 to 2 times, more preferably in the range of 0.1 to 1 times, the amount of the organic acid anhydride on a molar basis.

In the “solution thermal imidization method” or the “chemical imidization method”, the reaction solution contains components such as the catalyst, the chemical imidizing agent, and carboxylic acids produced as by-products (hereinafter referred to as impurities) and thus may be purified by removal thereof. For the purification, a known method can be used. For example, one of the most convenient methods is a method in which the reaction solution subjected to imidization is added dropwise into a large amount of poor solvent with stirring to precipitate the polyimide, and then the polyimide powder is recovered and repeatedly washed until the impurities are removed. Poor solvents suitable for use here are water and alcohols such as methanol, ethanol, and isopropanol, which cause the polyimide to precipitate, allow the impurities to be efficiently removed, and are readily dried, and these may be used as a mixture. If the concentration of the polyimide solution added dropwise into the poor solvent to cause precipitation is excessively high, the polyimide precipitated becomes a granular mass, so that the impurities may remain in the coarse particles, or it may take a long time to dissolve the obtained polyimide powder in the solvent. On the other hand, if the concentration of the polyimide solution is excessively low, a great amount of poor solvent is required, which is not preferred because disposal of waste solvent leads to an increased environmental load and a higher production cost. Therefore, the concentration of the polyimide solution added dropwise into the poor solvent is 20 wt % or less, more preferably 10 wt % or less. The amount of the poor solvent used here is preferably equal to or more than, suitably 1.5 to 3 times, the amount of the polyimide solution.

The polyimide powder obtained is recovered, and residual solvent is removed by, for example, vacuum drying or hot-air drying, whereby the polyimide according to the present invention can be obtained. The temperature and time of drying are not limited as long as the polyimide does not degrade or the residual solvent does not decompose at the temperature, and drying in a temperature range of 30° C. to 200° C. for 48 hours or less is preferred.

The intrinsic viscosity of the polyimide according to the present invention is preferably in the range of 0.1 to 10.0 dL/g, more preferably in the range of 0.2 to 5.0 dL/g.

The polyimide according to the present invention is soluble in various organic solvents and thus can be formed into a polyimide varnish. As an organic solvent therefor, a solvent can be selected according to the intended use and processing conditions of the varnish. Examples of solvents that can be used include, but are not limited to, amide solvents such as N, N-dimethylformamide, N, N-dimethylacetamide, and N-methyl-2-pyrrolidone and dimethylsulfoxide. Of these, from the viewpoint of solubility, amide solvents such as N, N-dimethylformamide, N, N-dimethylacetamide, and N-methyl-2-pyrrolidone are preferably used. These solvents may be used as a mixture of two or more.

The solids concentration at the time when the polyimide according to the present invention is dissolved in a solvent to form a solution is preferably 5 wt % or more, while depending on the molecular weight of the polyimide, the production method, and the processed product to be produced. An excessively low solids concentration may result in difficulty in processing into a sufficient thickness, whereas a high solids concentration may result in difficulty in performing processing because of an excessively high solution viscosity. The method of dissolving the polyimide contained in the material for melt processing according to the present invention in a solvent is, for example, as follows: while the solvent is stirred, the polyimide powder contained in the material for melt processing according to the present invention is added and dissolved in air or an inert gas in a temperature range from room temperature to the boiling point of the solvent over 1 to 48 hours, whereby a polyimide solution (varnish) can be formed.

For the polyimide solution obtained, the polyimide can be formed into various shapes by known methods. For example, when formed into a film, the polyimide solution is cast on a support such as a glass substrate using a doctor blade or the like and dried using a hot-air dryer, an infrared drying furnace, a vacuum dryer, an inert oven, or the like typically in the range of 40° C. to 350° C., preferably in the range of 50° C. to 250° C., whereby the film can be formed.

The polyimide according to the present invention can be used as, for example, materials for transparent substrates and cover films for devices for display units (e.g., liquid crystal displays, plasma displays, organic EL displays, flexible displays, foldable displays, rollable displays, and 3D displays), touch panels, organic EL illuminators, solar cells, and the like; materials for optical films (e.g., light guide plates, polarizing plates, polarizing plate protective films, retardation films, light diffusion films, wide view films, reflective films, antireflective films, antiglare films, brightness enhancement films, prism sheets, and light guide films); insulating materials for electronic components; materials for passivation films, buffer coating films, interlayer insulating films, and the like in semiconductor devices; materials for wiring boards such as flexible printed circuit boards and metal-clad laminates; wire coating materials for aircraft, motors, generators, and the like; luminescent materials for organic EL devices; materials for optical sensors; materials for optical radar; material for 3D displays; and the like.

### EXAMPLES

The present invention will now be described more specifically with reference to Examples, but it should be noted that the present invention is not limited to these Examples.

Analysis methods in the present invention are as follows.

### <Analysis Methods>

### 1. Infrared Absorption Spectrum

For the infrared absorption spectrum of a polyimide thin film, a polyimide thin film sample (15 μm thick) was measured using an FT/IR4200 Fourier transform infrared spectrophotometer (manufactured by JASCO Corporation) by an ATR (attenuated total reflection) method using a Ge prism.

### 2. ¹H-NMR Spectrum

For the 1H-NMR spectrum of a polyimide thin film, a polyimide thin film sample was partially dissolved in deuterated dimethylsulfoxide (DMSO-d₆) and measured using a JNM.ECP400 Fourier transform nuclear magnetic resonance spectrometer (manufactured by JEOL Ltd.). As a chemical shift reference, TMS (tetramethylsilane) was used.

### 3. Glass Transition Temperature: Tg

The glass transition temperature of a polyimide thin film was determined as follows: using a TMA60 thermomechanical analyzer (manufactured by Shimadzu Corporation), a sample having a size of 5 mm wide and 10 mm long under a load of 5 g was once heated to 150° C. at 10° C./min (first heating), then cooled to 20° C., and further heated at 10° C./min (second heating), and a tangent method of a TMA curve of the second heating (the intersection of a tangent of the glassy state and a tangent after Tg) was used to determine the glass transition temperature.

### 4. Average Coefficient of Linear Thermal Expansion: CTE

The average coefficient of linear thermal expansion of a polyimide thin film was calculated as follows: using a TMA60 thermomechanical analyzer (manufactured by Shimadzu Corporation), a sample having a size of 5 mm wide and 10 mm long under a load of 5 g was once heated to 150° C. at 10° C./min (first heating), then cooled to 20° C., and further heated at 10° C./min (second heating), and a TMA curve of the second heating was used to calculate the average coefficient of linear thermal expansion. The coefficient of linear thermal expansion was determined as an average in the range of 80° C. to 200° C.

### 5. Thermal Decomposition Temperature (Nitrogen Atmosphere): Td

The thermal decomposition temperature of a polyimide thin film was measured as follows: using a TG-DTA60 thermogravimetric analyzer (manufactured by Shimadzu Corporation), the temperature at which the residual weight percentage based on the weight at 100° C. reaches 95% in a heating process at a heating rate of 10° C./min in a nitrogen atmosphere was measured as the thermal decomposition temperature (Td). Higher thermal decomposition temperature values indicate higher thermal stability.

### 6. Ultraviolet-Visible Light Transmission Properties

For the light transmission properties of a polyimide thin film in the ultraviolet-visible range, a polyimide thin film sample formed on a quartz substrate was measured in the range of wavelengths from 250 to 800 nm using a V-670 ultraviolet-visible spectrophotometer (manufactured by JASCO Corporation). In an optical path for the measurement, a Glan-Taylor polarizer having a high degree of polarization in the ultraviolet-visible range was inserted to provide p-polarized light, and the measurement sample was inclined so as to form a Brewster angle (about) 60° with respect to the optical path, whereby the influence of multiple reflection on the thin film surface was minimized.

### 7. Average Refractive Index: nₐᵥ and Birefringence: Δn

For the refractive index of a polyimide thin film, a polyimide thin film sample formed on a silicon substrate was measured at wavelengths of 636 nm, 845 nm, 1310 nm, and 1558 nm using a PC-2010 prism coupler (manufactured by Metricon Corporation). Here, refractive indices in a direction parallel to the film surface (n_{TE}) and a direction perpendicular to the film surface (film thickness direction) (n_{TM}) were measured by rotating the linearly polarized plane of laser light while inserting a half-wave plate corresponding to each wavelength into an optical path. From these refractive indices, the average refractive index (nₐᵥ²=(2n_{TE}²+n_{TM}²)/3) and the birefringence (Δn=n_{TE}−n_{TM}) Of the polyimide film were calculated.

### 8. Dielectric Constant (Estimated Value): ε_{ref}

The dielectric constant (estimated value) of a polyimide thin film was calculated as (ϵ_{ref}=1.1×nₐᵥ²) on the basis of the average refractive index nₐᵥ at a wavelength of 1310 nm.

### 9. Dielectric Constant and Dielectric Loss Tangent (Measured Values)

The dielectric constant and dielectric loss tangent of a polyimide thin film were measured at frequencies of 10 GHZ and 20 GHz in a TE mode using a VNA network analyzer MS46122B (manufactured by Anritsu Corporation) and a cavity resonator (10 GHz, 20 GHZ) (manufactured by aet Inc.). The measurement was performed after the polyimide thin film was dried at 120° C. for 2 hours and then subjected to humidity control in an environment at 23° C.±1° C. and 50% RH±5% for 24 hours.

### 10. Circular Dichroism: CD

For the circular dichroism (CD) of a polyimide thin film, a polyimide thin film sample formed on a quartz substrate was measured in the range of wavelengths from 190 to 500 nm using a J-1000 circular dichroism spectrometer (manufactured by manufactured by JASCO Corporation).

### 11. Solubility Test

For the solubility of a polyimide thin film in a solvent, 0.1 g of the polyimide thin film and 9.9 g (solids concentration: 1 wt %) of each solvent shown in Table 3 were placed in a glass sample tube and stirred for 60 minutes using a test tube mixer, and the state of dissolution was visually observed. As solvents, N, N-dimethylacetamide (DMAc), N-methyl-2-pyrrolidone (NMP), dimethylsulfoxide (DMSO), and γ-butyrolactone (GBL) were used. The evaluation results are shown in Table 3 as follows: “++”, dissolved at room temperature; “+”, dissolved by heating and remained homogeneous after being allowed to cool to room temperature; “±”, swollen/partially dissolved; and “−”, undissolved.

### <Synthesis Example 1> Synthesis of Compound (i) (Isosorbide-Bis (Trimellitate Anhydride)

Isosorbide and a 30-fold amount of anhydrous dichloromethane were loaded into a four-necked flask equipped with a thermometer, a stirrer, and a condenser, and while the liquid mixture was dissolved by stirring, triethylamine in an amount 1.1 times that of the isosorbide on a molar basis was added thereto. Furthermore, trimellitic anhydride chloride in an amount 2.1 times that of the isosorbide on a molar basis was added, and the mixture was stirred at 0° C. for 20 hours.

The precipitate formed was separated by filtration, and the filtrate was slowly added dropwise into a 30-fold amount of petroleum ether to obtain a white solid. The white solid obtained was separated by filtration and dried at 80° C. under reduced pressure. The resulting white solid was dissolved in deuterated dimethylsulfoxide (DMSO-d₆), and analyzed by ¹H-NMR and identified as compound (i), which was the target compound.

### <Synthesis Example 2> Synthesis of Compound (iii) (Isomannide-Bis(Trimellitate Anhydride)

Isomannide and a 38-fold amount of anhydrous dimethylacetamide were loaded into a four-necked flask equipped with a thermometer, a stirrer, and a condenser, and while the liquid mixture was dissolved by stirring, triethylamine in an amount 1.1 times that of the isomannide on a molar basis was added thereto. Furthermore, trimellitic anhydride chloride in an amount 2.1 times that of the isomannide on a molar basis was added, and the mixture was stirred at 20° C. for 28 hours.

The precipitate formed was separated by filtration, and the filtrate was slowly added dropwise into a 38-fold amount of petroleum ether to obtain a white solid. The white solid obtained was separated by filtration and dried at 80° C. under reduced pressure. The resulting white solid was dissolved in deuterated chloroform (CDCl₃), and analyzed by 1H-NMR and identified as compound (iii), which was the target compound.

### Example 1

In a nitrogen atmosphere, 0.571 g (5 mmol) of 1,4-cyclohexanediamine (DACH) and 1.29 g of N,O-bis (trimethylsilyl)trifluoroacetamide (BSTFA) were dissolved in 12.6 g of dehydrated N, N-dimethylacetamide (DMAc) in a glass container with a lid, and 2.472 g (5 mmol) of compound (i) synthesized according to <Synthesis Example 1> was added in several portions. The resulting mixture was dissolved with stirring with a magnetic stirring bar. Thereafter, stirring was performed at room temperature for 12 hours to obtain a polyamic acid solution as a polyimide precursor (solids concentration: 18.0 wt %). The polyamic acid solution was spread on a silicon substrate or fused quartz substrate placed on a spin coater, and a film was formed by spin coating and transferred into a heating furnace (inert oven) together with the substrate. Thereafter, under a stream of nitrogen, the film was dried at 70° C. for 50 minutes, then heated to 280° C. at a heating rate of 3° C./min, held at 280° C. for 90 minutes, and then naturally cooled to room temperature. The film was peeled off the substrate to obtain a colorless, transparent polyimide thin film. Polyimide thin films prepared for the purpose of optical measurements (light transmission properties, refractive index, and circular dichroism) were used for the measurements without being peeled off the substrate. The polyimide thin film obtained was stored in a dry desiccator. The structural formula of the polyimide of Example 1 is shown below.

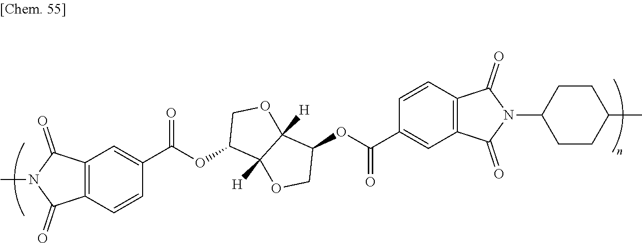

### Example 2

In a nitrogen atmosphere, 1.601 g (5 mmol) of 2,2′-bis(trifluoromethyl) benzidine (TFDB) was dissolved in 12.9 g of dehydrated N, N-dimethylacetamide (DMAc) in a glass container with a lid, and 2.472 g (5 mmol) of compound (i) was added in several portions. The resulting mixture was dissolved with stirring with a magnetic stirring bar. Thereafter, stirring was performed at room temperature for 12 hours to obtain a polyamic acid solution as a polyimide precursor (solids concentration: 24.0 wt %). The polyamic acid solution was spread on a silicon substrate or fused quartz substrate placed on a spin coater, and a film was formed by spin coating and transferred into a heating furnace together with the substrate. Thereafter, under a stream of nitrogen, the film was dried at 70° C. for 50 minutes, then heated to 280° C. at a heating rate of 3° C./min, held at 280° C. for 90 minutes, and then naturally cooled to room temperature. The film was peeled off the substrate to obtain a colorless, transparent polyimide thin film. Polyimide thin films prepared for the purpose of optical measurements (light transmission properties, refractive index, and circular dichroism) were used for the measurements without being peeled off the substrate. The polyimide thin film obtained was stored in a dry desiccator. The structural formula of the polyimide of Example 2 is shown below.

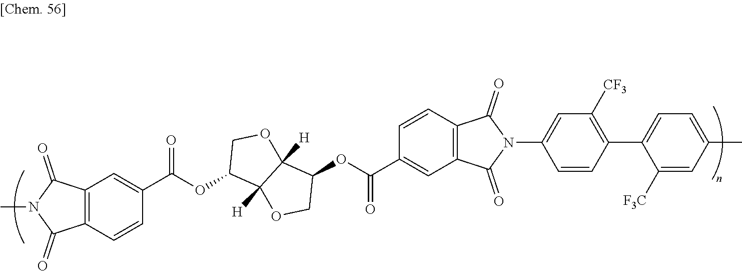

### Example 3

In a nitrogen atmosphere, 1.00 g (5 mmol) of 4,4′-diaminodiphenyl ether (ODA) was dissolved in 17.0 g of dehydrated N, N-dimethylacetamide (DMAc) in a glass container with a lid, and 2.472 g (5 mmol) of compound (i) was added in several portions. The resulting mixture was dissolved with stirring with a magnetic stirring bar. Thereafter, stirring was performed at room temperature for 12 hours to obtain a polyamic acid solution as a polyimide precursor (solids concentration: 18.0 wt %). The polyamic acid solution was spread on a silicon substrate or fused quartz substrate placed on a spin coater, and a film was formed by spin coating and transferred into a heating furnace together with the substrate. Thereafter, under a stream of nitrogen, the film was dried at 70° C. for 50 minutes, then heated to 280° C. at a heating rate of 3° C./min, held at 280° C. for 90 minutes, and then naturally cooled to room temperature. The film was peeled off the substrate to obtain a pale yellow polyimide thin film. Polyimide thin films prepared for the purpose of optical measurements (light transmission properties, refractive index, and circular dichroism) were used for the measurements without being peeled off the substrate. The polyimide thin film obtained was stored in a dry desiccator. The structural formula of the polyimide of Example 3 is shown below.

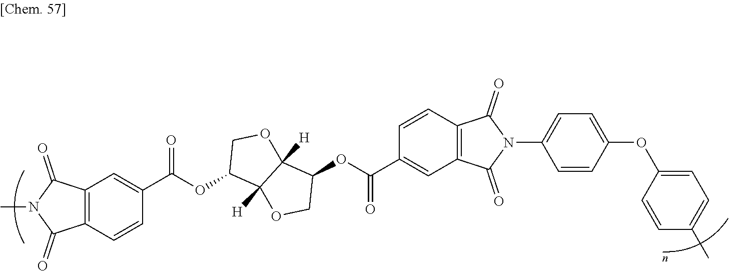

### <Example 4> Example of Compound (i): Compound (iii)=9:1 (Molar Ratio)

In a nitrogen atmosphere, 1.60 g (5 mmol) of 2,2′-bis(trifluoromethyl) benzidine (TFDB) was dissolved in 12.9 g of dehydrated N, N-dimethylacetamide (DMAc) in a glass container with a lid, and 0.247 g (0.5 mmol) of compound (iii) was added. The resulting mixture was dissolved with stirring with a magnetic stirring bar. Thereafter, stirring was performed at room temperature for 6 hours, and 0.225 g (4.5 mmol) of compound (i) was further added in several portions. The resulting mixture was dissolved with stirring with a magnetic stirring bar. Thereafter, stirring was performed at room temperature for 12 hours to obtain a polyamic acid solution as a polyimide precursor (solids concentration: 24.0 wt %). The polyamic acid solution was spread on a silicon substrate or fused quartz substrate placed on a spin coater, and a film was formed by spin coating and transferred into a heating furnace together with the substrate. Thereafter, under a stream of nitrogen, the film was dried at 70° C. for 50 minutes, then heated to 280° C. at a heating rate of 3° C./min, held at 280° C. for 90 minutes, and then naturally cooled to room temperature. The film was peeled off the substrate to obtain a colorless, transparent polyimide thin film. Polyimide thin films prepared for the purpose of optical measurements (light transmission properties and refractive index) were used for the measurements without being peeled off the substrate. The polyimide thin film obtained was stored in a dry desiccator. The structural formula of the polyimide of Example 4 is shown below. The ratio of m to n in the following structural formula is 9:1.

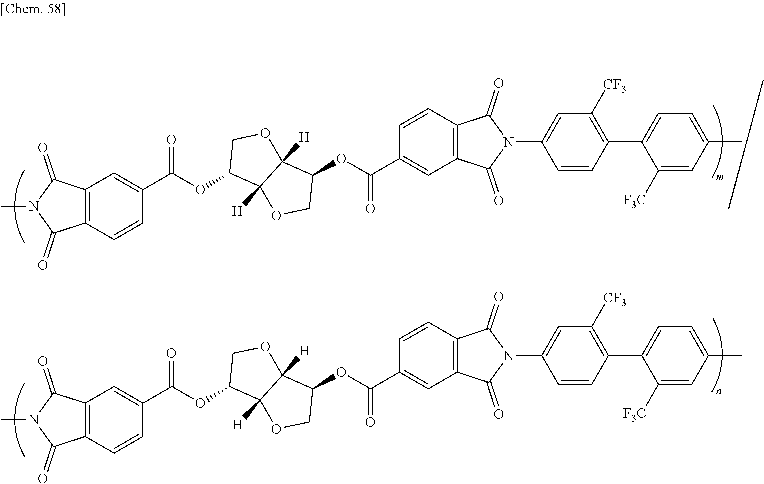

### <Example 5> Example of Compound (i): Compound (iii)=8:2 (Molar Ratio)

In a nitrogen atmosphere, 1.60 g (5 mmol) of 2,2′-bis(trifluoromethyl) benzidine (TFDB) was dissolved in 12.9 g of dehydrated N, N-dimethylacetamide (DMAc) in a glass container with a lid, and 0.494 g (1 mmol) of compound (iii) was added. The resulting mixture was dissolved with stirring with a magnetic stirring bar. Thereafter, stirring was performed at room temperature for 6 hours, and 1.977 g (4 mmol) of compound (i) was further added in several portions. The resulting mixture was dissolved with stirring with a magnetic stirring bar. Thereafter, stirring was performed at room temperature for 12 hours to obtain a polyamic acid solution as a polyimide precursor (solids concentration: 24.0 wt %). The polyamic acid solution was spread on a silicon substrate or fused quartz substrate placed on a spin coater, and a film was formed by spin coating and transferred into a heating furnace together with the substrate. Thereafter, under a stream of nitrogen, the film was dried at 70° C. for 50 minutes, then heated to 280° C. at a heating rate of 3° C./min, held at 280° C. for 90 minutes, and then naturally cooled to room temperature. The film was peeled off the substrate to obtain a colorless, transparent polyimide thin film. Polyimide thin films prepared for the purpose of optical measurements (light transmission properties and refractive index) were used for the measurements without being peeled off the substrate. The polyimide thin film obtained was stored in a dry desiccator. Here, the structural formula of the polyimide of Example 5 is the same as the structural formula shown in Example 4, and the ratio of m to n is 8:2.

### Example 6

A polyimide was produced by the same preparation method as in Example 4 except that the molar ratio of compound (i) to compound (iii) in Example 4 was changed to 7:3.

### Example 7

A polyimide was produced by the same preparation method as in Example 4 except that the molar ratio of compound (i) to compound (iii) in Example 4 was changed to 6:4.

### Example 8

A polyimide was produced by the same preparation method as in Example 4 except that the molar ratio of compound (i) to compound (iii) in Example 4 was changed to 5:5.

### Example 9

In a nitrogen atmosphere, 1.761 g (10 mmol) of 5-trifluoromethyl-1,3-phenylenediamine (TFMPD) was dissolved in 21.2 g of dehydrated N, N-dimethylacetamide (DMAc) in a glass container with a lid, and 4.944 g (10 mmol) of compound (i) was added in several portions. The resulting mixture was dissolved with stirring with a magnetic stirring bar. Thereafter, stirring was performed at room temperature for 12 hours to obtain a polyamic acid solution as a polyimide precursor (solids concentration: 24.0 wt %). The polyamic acid solution was spread on a silicon substrate or fused quartz substrate placed on a spin coater, and a film was formed by spin coating and transferred into a heating furnace together with the substrate. Thereafter, under a stream of nitrogen, the film was dried at 70° C. for 50 minutes, then heated to 280° C. at a heating rate of 3° C./min, held at 280° C. for 90 minutes, and then naturally cooled to room temperature. The film was peeled off the substrate to obtain a colorless, transparent polyimide thin film. Polyimide thin films prepared for the purpose of optical measurements (light transmission properties, refractive index, and circular dichroism) were used for the measurements without being peeled off the substrate. The polyimide thin film obtained was stored in a dry desiccator. The structural formula of the polyimide of Example 9 is shown below.

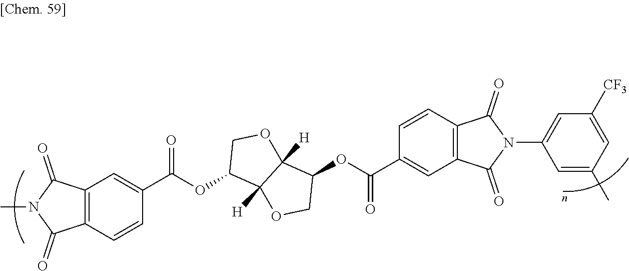

### Example 10

In a nitrogen atmosphere, 1.081 g (10 mmol) of 1,4-phenylenediamine (PPD) was dissolved in 27.4 g of dehydrated N, N-dimethylacetamide (DMAc) in a glass container with a lid, and 4.944 g (10 mmol) of compound (i) was added in several portions. The resulting mixture was dissolved with stirring with a magnetic stirring bar. Thereafter, stirring was performed at room temperature for 12 hours to obtain a polyamic acid solution as a polyimide precursor (solids concentration: 18.0 wt %). The polyamic acid solution was spread on a silicon substrate or fused quartz substrate placed on a spin coater, and a film was formed by spin coating and transferred into a heating furnace together with the substrate. Thereafter, under a stream of nitrogen, the film was dried at 70° C. for 50 minutes, then heated to 280° C. at a heating rate of 3° C./min, held at 280° C. for 90 minutes, and then naturally cooled to room temperature. The film was peeled off the substrate to obtain a pale yellow polyimide thin film. Polyimide thin films prepared for the purpose of optical measurements (light transmission properties, refractive index, and circular dichroism) were used for the measurements without being peeled off the substrate. The polyimide thin film obtained was stored in a dry desiccator. The structural formula of the polyimide of Example 10 is shown below.

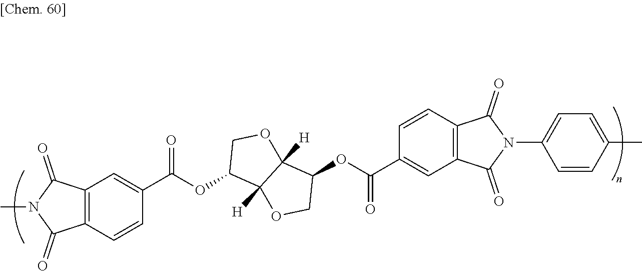

### Example 11

A polyimide was produced by the same preparation method as in Example 10 except that 1,4-phenylenediamine (PPD) in Example 10 was replaced with its structural isomer 1,3-phenylenediamine (MPD). The structural formula of the polyimide of Example 11 is shown below.

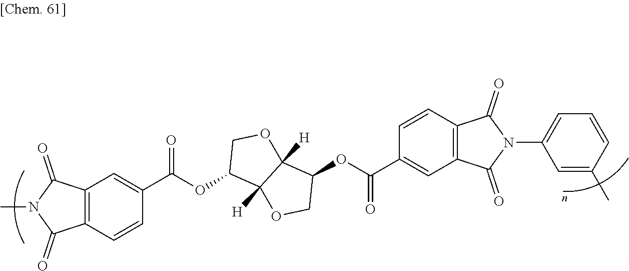

Physical properties of the polyimide thin films of Examples 1 to 11 evaluated as described below are listed in Tables 1 and 2 below. In Table 1, T₄₀₀ (%) and T₄₅₀ (%) mean light transmittances (%) at wavelengths of 400 nm and 450 nm, respectively, and λ (T_{95%}) means a wavelength (nm) at which the light transmittance (%) is 95%.

TABLE 1

| | | | | | | | CD |
|---|---|---|---|---|---|---|---|
| | | Average | Thermal | | | | properties |
| | Glass | coefficient of | decomposition | Light | | | Cotton |
| | transition | linear | temperature | transmission | | | effect |
| | temperature | thermal | (5% weight | properties | | | (peak |
| | (TMA tangent) | expansion | reduction) | T₄₀₀ | T₄₅₀ | λ | wavelength, |
| | ° C. | ppm/K | ° C. | (%) | (%) | (T_{95%}) | nm) |
| Example 1 | 260 | 48 | 403 | 91.7 | 94.5 | 485 | negative |
| | | | | | | | (238) |
| Example 2 | 258 | 50 | 400 | 85.7 | 97.8 | 420 | negative |
| | | | | | | | (230, 260) |
| Example 3 | 240 | 46 | 409 | 7.1 | 78.5 | 513 | negative |
| | | | | | | | (232, 264) |
| Example 4 | 256 | 46 | 408 | 83.6 | 98.0 | 418 | — |
| Example 5 | 259 | 52 | 414 | 80.5 | 98.5 | 419 | — |
| Example 6 | 265 | 47 | 417 | 83.7 | 98.0 | 420 | — |
| Example 7 | 260 | 67 | 414 | 85.2 | 99.1 | 415 | — |
| Example 8 | 256 | 62 | 410 | 80.6 | 98.2 | 422 | — |
| Example 9 | 265 | 44 | 409 | 90.3 | 97.5 | 416 | negative |
| | | | | | | | (232, 254) |
| Example 10 | 268 | 52 | 409 | 18.5 | 91.6 | 462 | negative |
| | | | | | | | (230, 274) |
| Example 11 | 260 | 53 | 403 | 76.4 | 98.5 | 423 | negative |
| | | | | | | | (234, 254) |

TABLE 2

| | Average | | Dielectric | | | Dielectric | |
|---|---|---|---|---|---|---|---|
| | refractive | | constant | Dielectric | | loss | |
| | index | Birefringence | (Estimated | constant | | tangent | |
| | (1310 nm) | (1310 nm) | value) | (10 GHz) | (20 GHz) | (10 GHz) | (20 GHz) |
| Example | 1.566 | 0.0054 | 2.70 | — | — | — | — |
| 1 | | | | | | | |
| Example | 1.555 | 0.0130 | 2.66 | 2.97 | 2.88 | 0.0105 | 0.0124 |
| 2 | | | | | | | |
| Example | 1.601 | 0.0086 | 2.82 | 3.06 | 2.99 | 0.0129 | 0.0144 |
| 3 | | | | | | | |
| Example | 1.557 | 0.0121 | 2.67 | 2.92 | 2.94 | 0.0092 | 0.0124 |
| 4 | | | | | | | |
| Example | 1.556 | 0.0120 | 2.66 | 2.92 | 2.94 | 0.0097 | 0.0125 |
| 5 | | | | | | | |
| Example | 1.554 | 0.0118 | 2.66 | 2.89 | 2.88 | 0.0101 | 0.0129 |
| 6 | | | | | | | |
| Example | 1.554 | 0.0105 | 2.66 | 3.02 | 2.97 | 0.0107 | 0.0133 |
| 7 | | | | | | | |
| Example | 1.554 | 0.0093 | 2.66 | 3.04 | 2.97 | 0.0120 | 0.0133 |
| 8 | | | | | | | |
| Example | 1.563 | 0.0075 | 2.69 | 3.18 | 3.11 | 0.0146 | 0.0162 |
| 9 | | | | | | | |
| Example | 1.603 | 0.0206 | 2.83 | 3.33 | 3.23 | 0.0165 | 0.0186 |
| 10 | | | | | | | |
| Example | 1.588 | 0.0071 | 2.77 | 3.33 | 3.25 | 0.0172 | 0.0200 |
| 11 | | | | | | | |

### <Confirmation of Completion of Imidization Reaction>

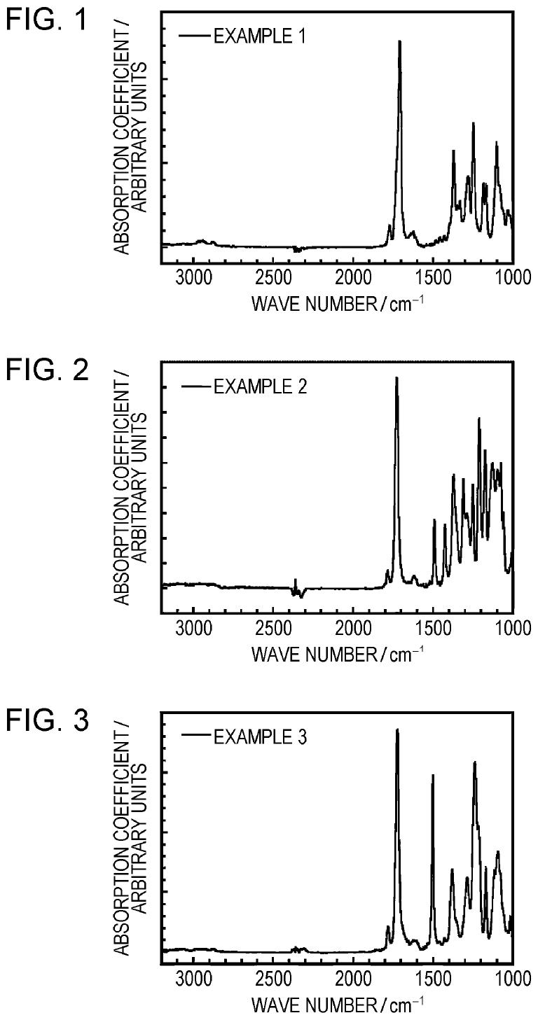

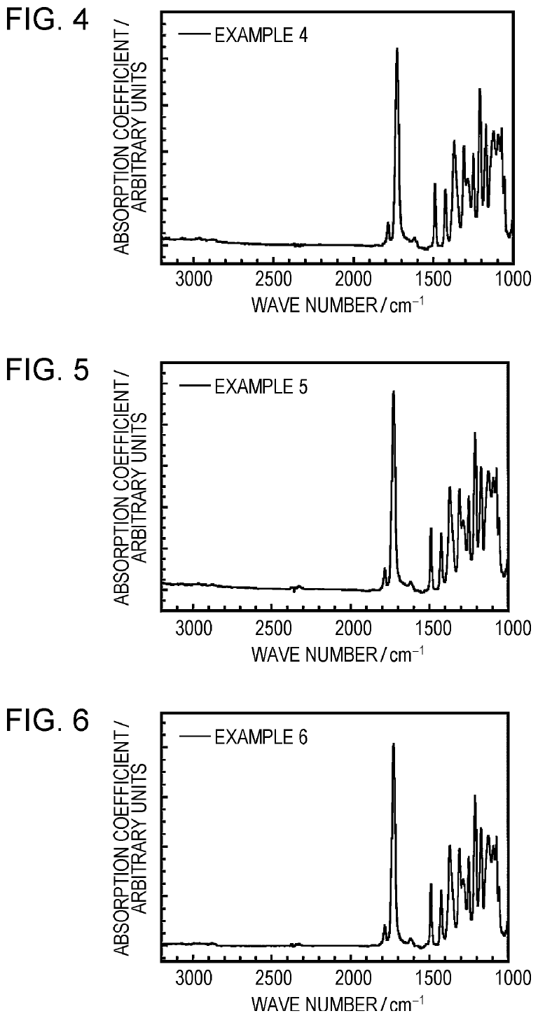

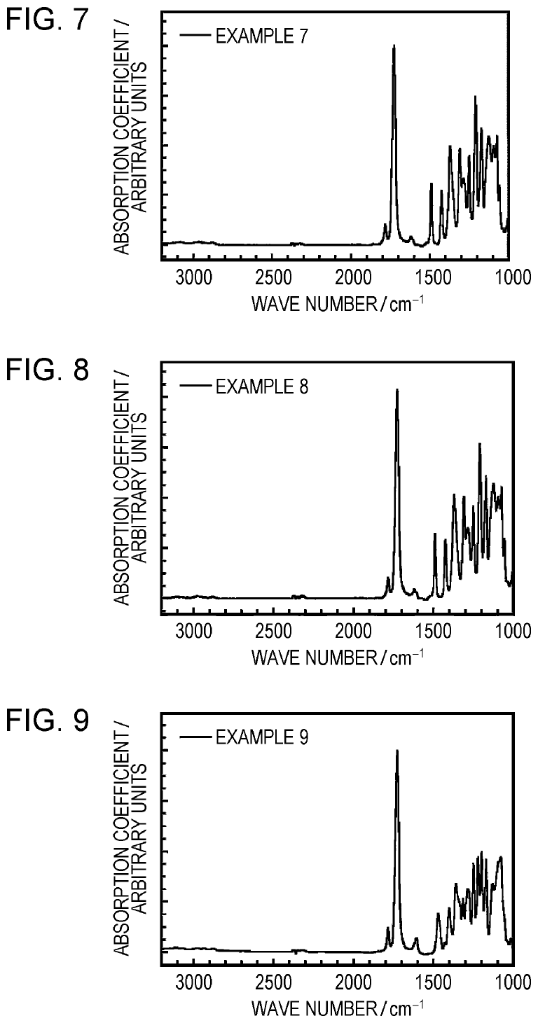

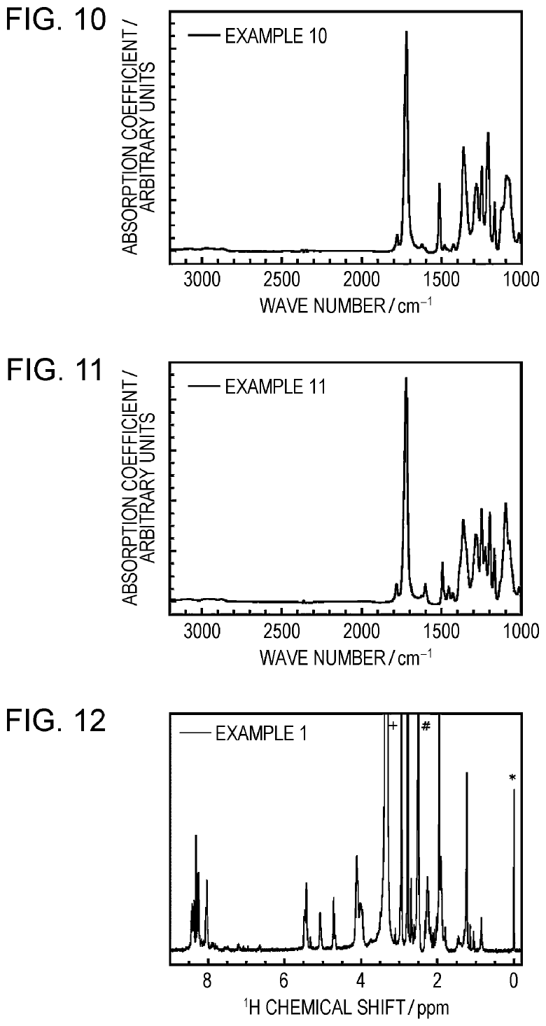

FIGS. 1 to 11 shows Fourier transform ATR (attenuated total reflection) infrared absorption spectra of the polyimide thin films (thickness: about 15 μm) obtained in Examples 1 to 11, respectively.

In FIGS. 1 to 11, peaks around 1760 cm⁻¹ are signals attributed to symmetric stretching vibration of two carbonyl carbons included in the imide group, peaks around 1700 cm⁻¹ are signals attributed to asymmetric stretching vibration of the two carbonyl carbons, and peaks around 1370 cm⁻¹ are signals attributed to stretching vibration of a single bond between the imide ring nitrogen (N) and the benzene-ring 1-position carbon or the cyclohexyl-group 1-position carbon. In addition, in FIGS. 2 to 11, peaks attributed to benzene-ring C═C stretching vibration of the diamine moiety are observed around 1480 to 1510 cm⁻¹. On the other hand, the peak of an amide group, which is observed when imidization is not completed, is not observed around 1670 cm⁻¹. This has shown that the thermal imidization reactions in Examples 1 to 11 were completed, and polyimide thin films were certainly obtained.

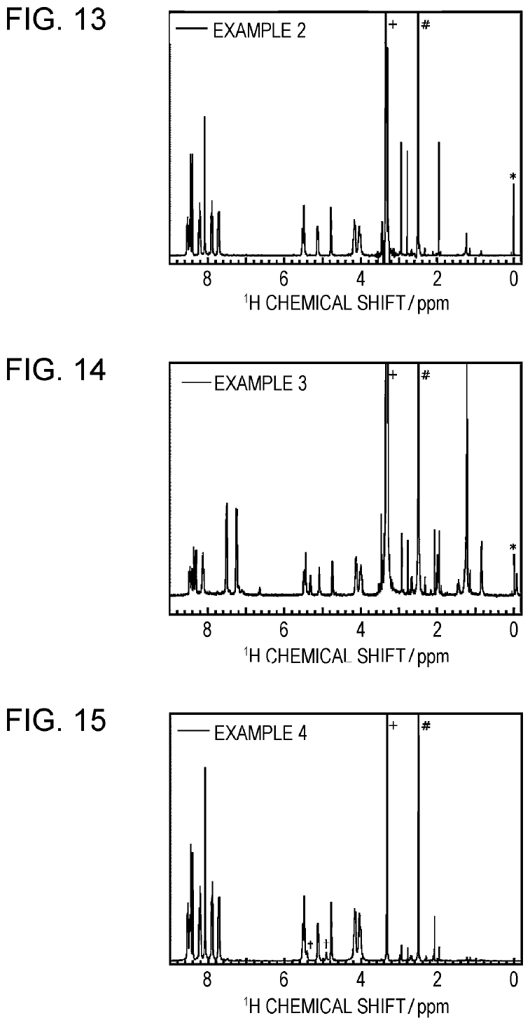

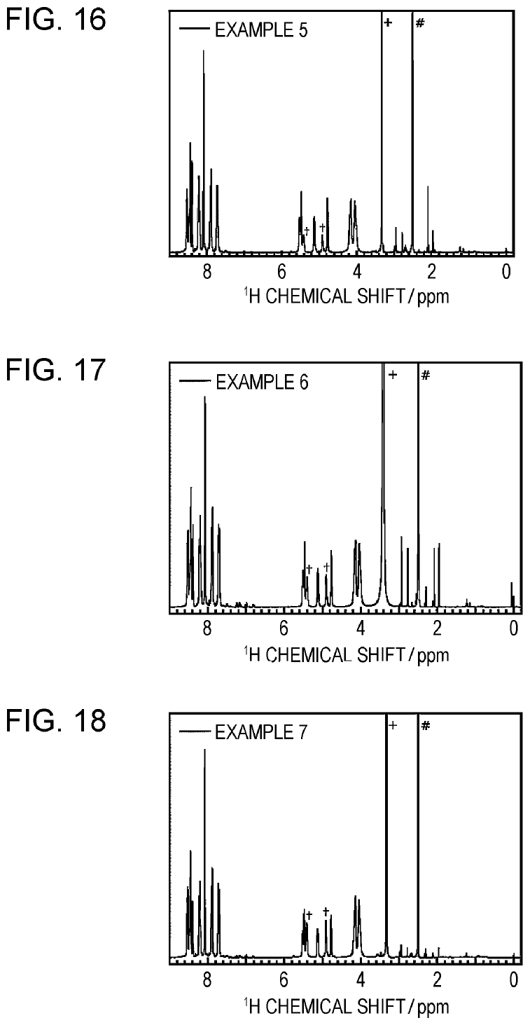

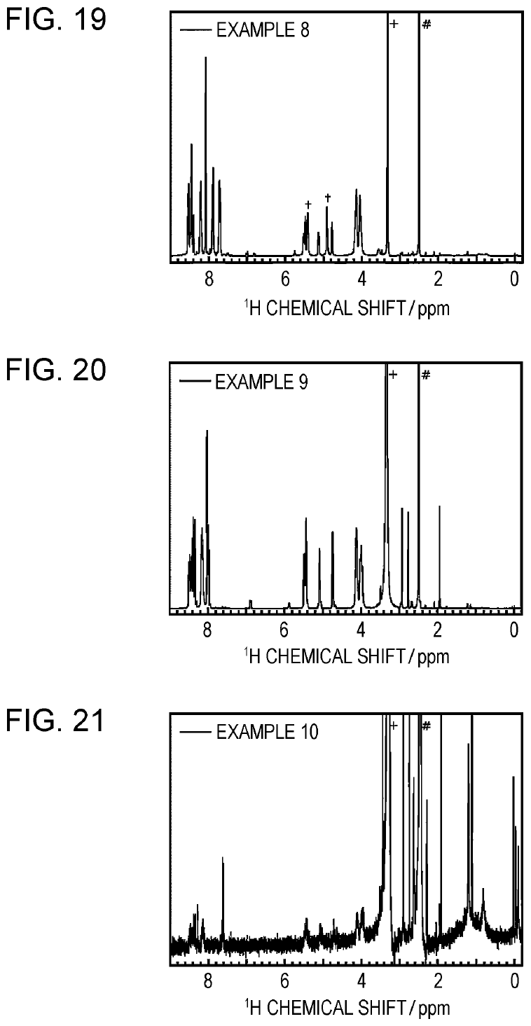

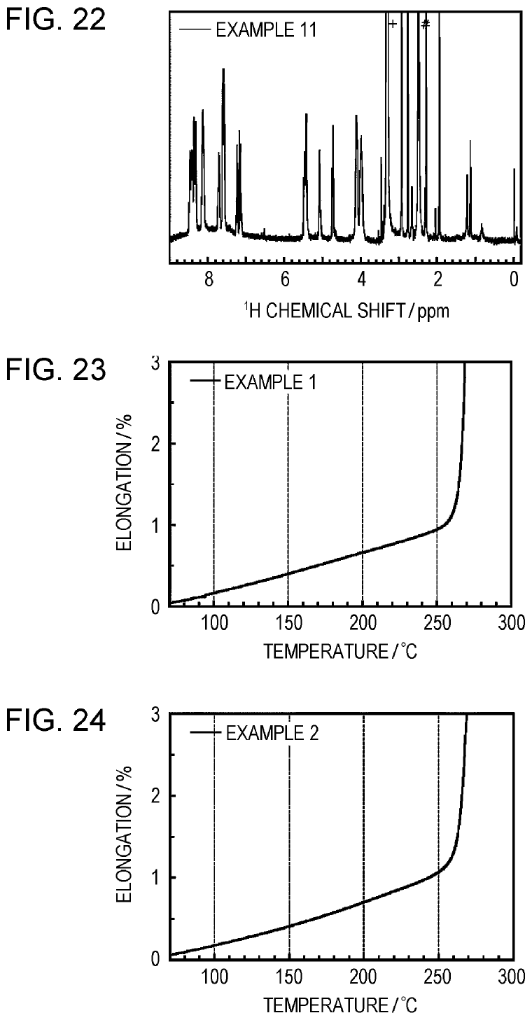

FIGS. 12 to 22 show 1H-NMR spectra of deuterated dimethylsufoxide (DMSO-d₆) solutions of the polyimide thin films of Examples 1 to 11.

In these FIGS. 12 to 22, * is a signal of TMS (reference material), #is a signal of DMSO (solvent), and + is a signal of water. Signals at 7.5 to 8.5 ppm are attributed to phenyl-group hydrogens, and signals at 4.5 to 5.5 ppm are attributed to hydrogens of alicyclic structures of isosorbide and isomannide. Here, peaks (†) at 4.9 ppm and 5.4 ppm observed in FIGS. 15 to 19 (Examples 4 to 8) are signals attributed to isomannide, and their intensity ratios have confirmed that isomannide is contained in an amount of 10 mol % to 50 mol % in each of the polyimide copolymers of Examples 4 to 8. In Example 1, the signal at 4.2 ppm is attributed to the 1-position hydrogen of the cyclohexyl group, and the signals at 1 to 3 ppm are attributed to hydrogens at positions other than the 1-position of the cyclohexyl group. In these spectra, all the main signals can be attributed to polyimide structures, and only the signals observed when imidization is completed are observed. This has shown that the thermal imidization reactions in Examples 1 to 11 were completed, and polyimide thin films were certainly obtained. For the polyimide of Example 10, the resolution of the spectrum is low and there is much noise because of very low solubility in DMSO-d₆, but signals characteristic of the molecular structure are observed.

### <Measurement of Glass Transition Temperature (Tg) and Average Coefficient of Linear Thermal Expansion (CTE)>

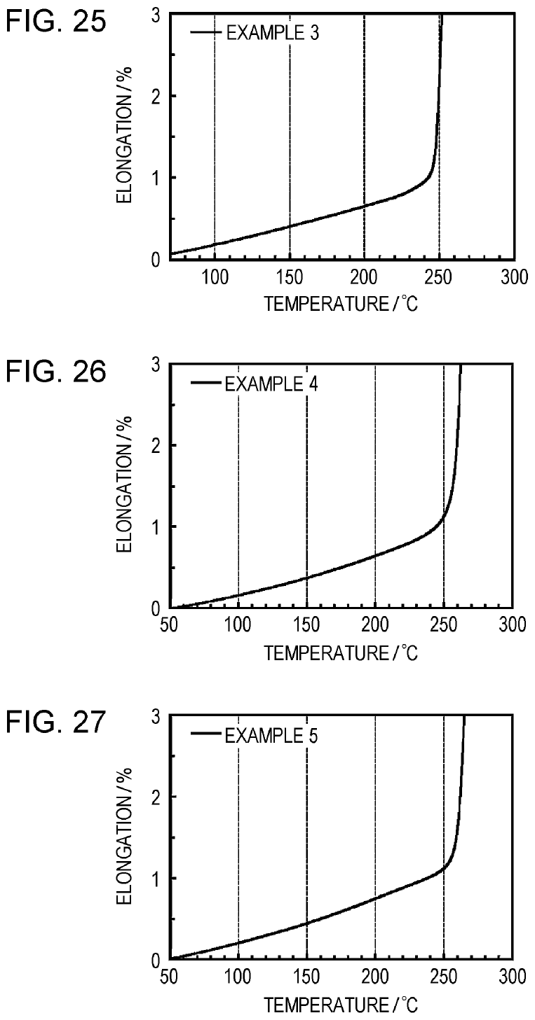

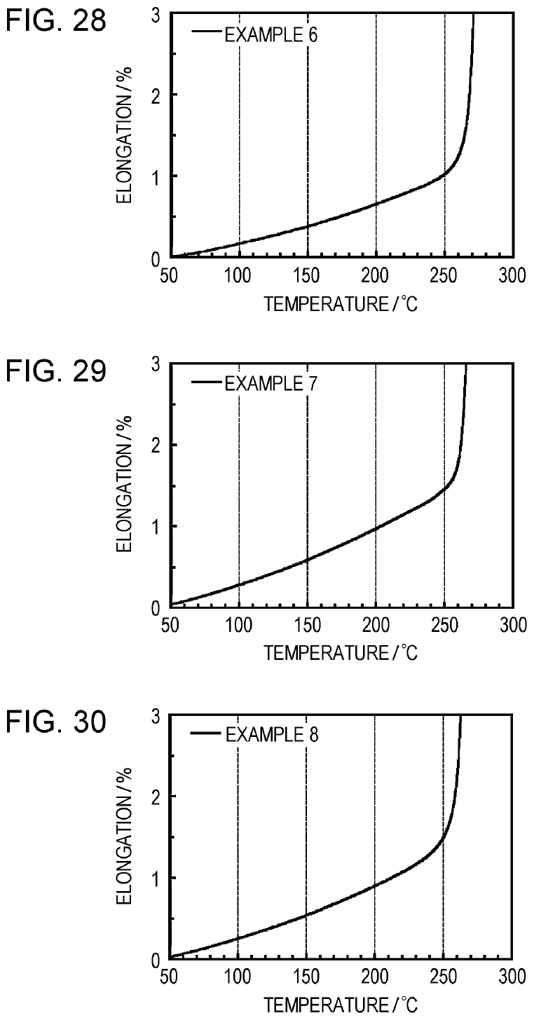

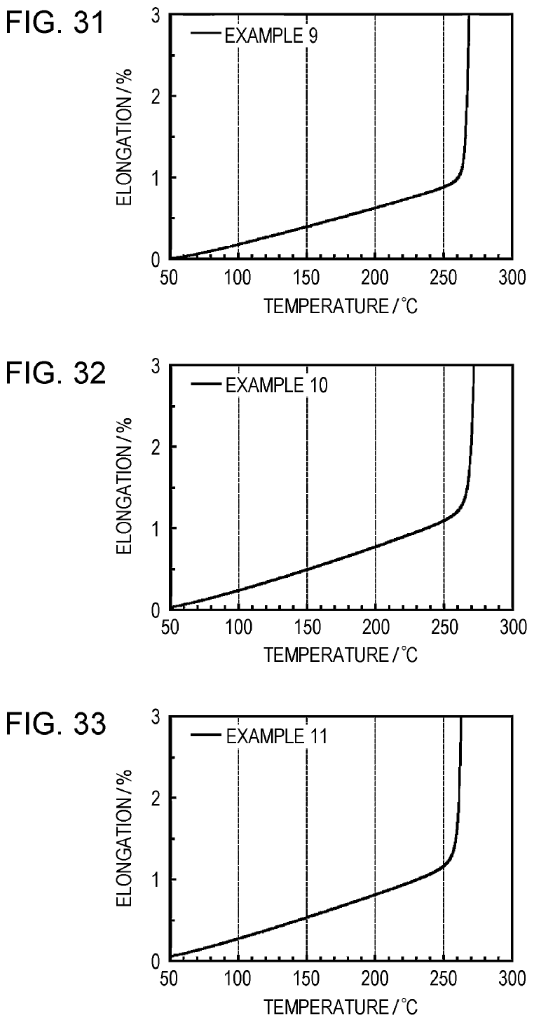

FIGS. 23 to 33 show charts of thermomechanical analysis (TMA) of the polyimide thin films (about 15 μm thick) of Examples 1 to 11. The glass transition temperature (Tg) determined from the intersection of a tangent of a low-temperature part (150° C. to 250° C.) and a tangent of a high-temperature part (270° C. to 275° C.) and the average coefficient of linear thermal expansion (CTE) determined at 80° C. to 200° C. are shown in Table 1.

Tg is in the range of 240° C. to 268° C. in each Example, which shows having a sufficiently high Tg for heat-resistant resins. It has also been shown that the CTE values are 44 to 67 ppm/K, which are standard or slightly small for polyimides having isotropic chemical structures (NPL 1: S. Ando et al., Macromolecular Chemistry and Physics, 2017, U.S. Pat. No. 1,700,354, (2017)).

### <Measurement of Thermal Decomposition Temperature>

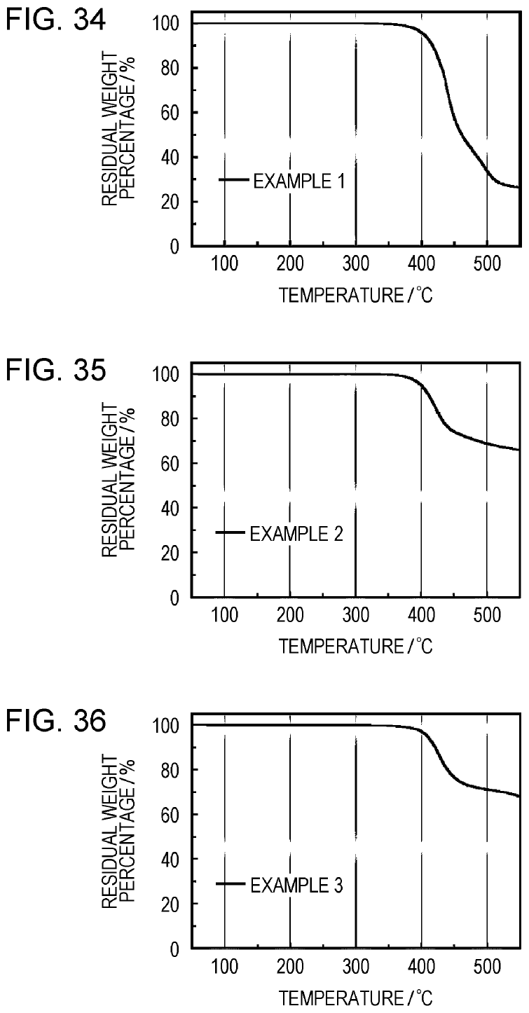

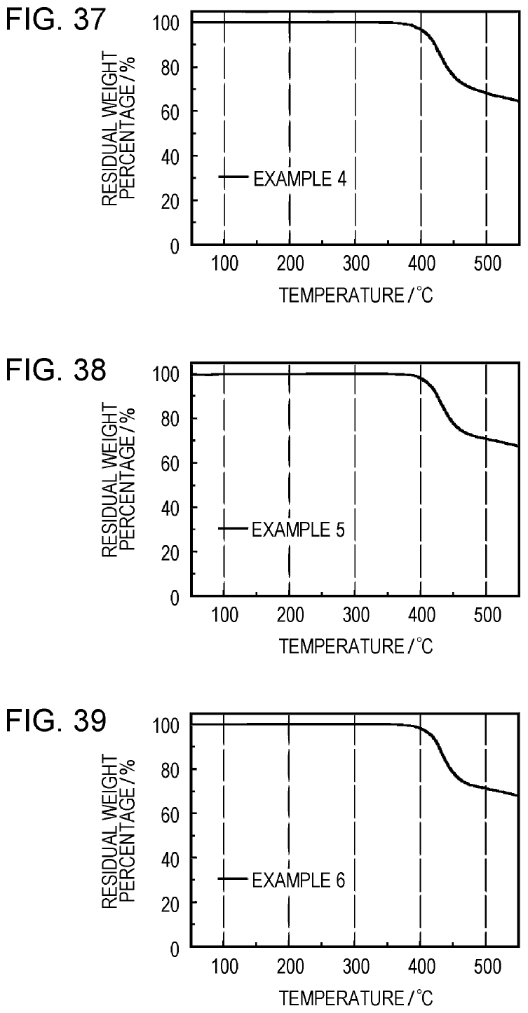

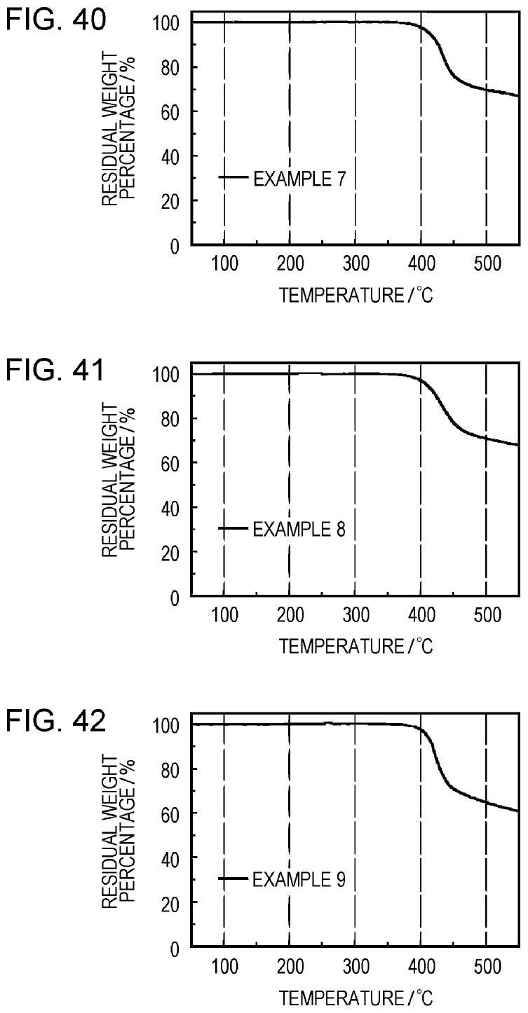

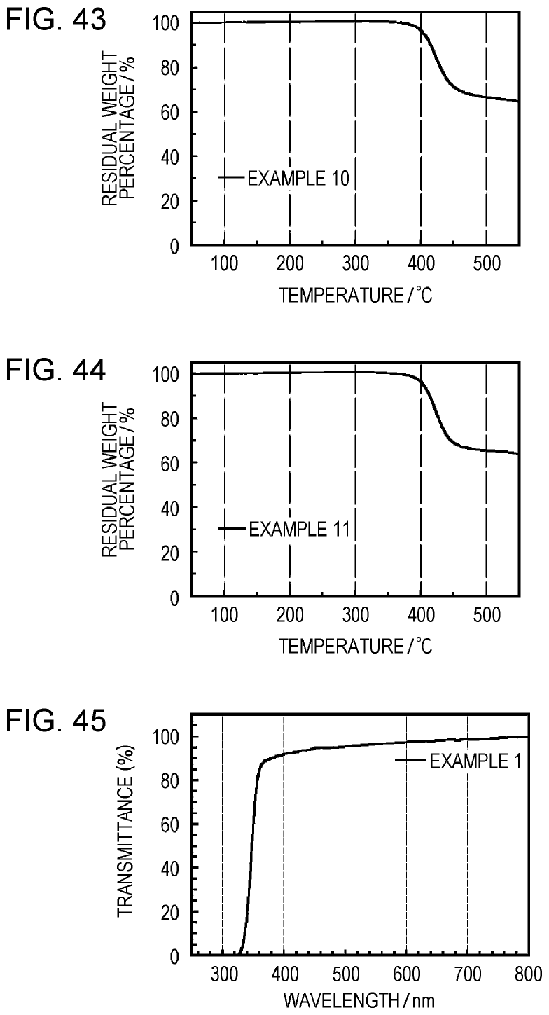

FIGS. 34 to 44 show charts of thermogravimetric analysis (TGA) of the polyimide thin films (about 15 μm thick) of Examples 1 to 11. The thermal decomposition temperature (Td) at which the residual weight percentage based on the weight at 100° C. reaches 95% is shown in Table 1. Td is in the range of 400° C. to 417° C. in each Example, which shows having a sufficiently high thermal decomposition temperature for heat-resistant resins.

### <Evaluation of Ultraviolet-Visible Light Transmission Properties>

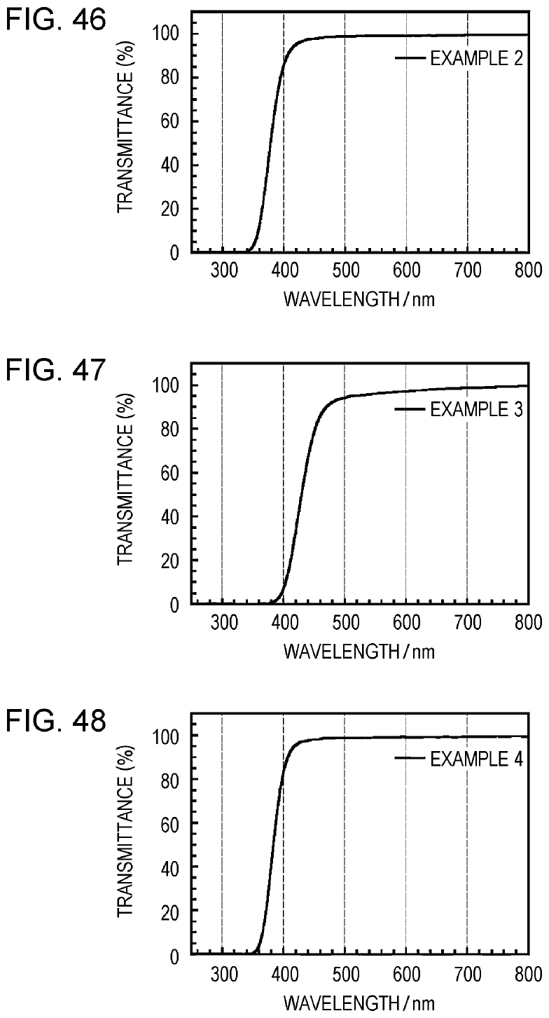

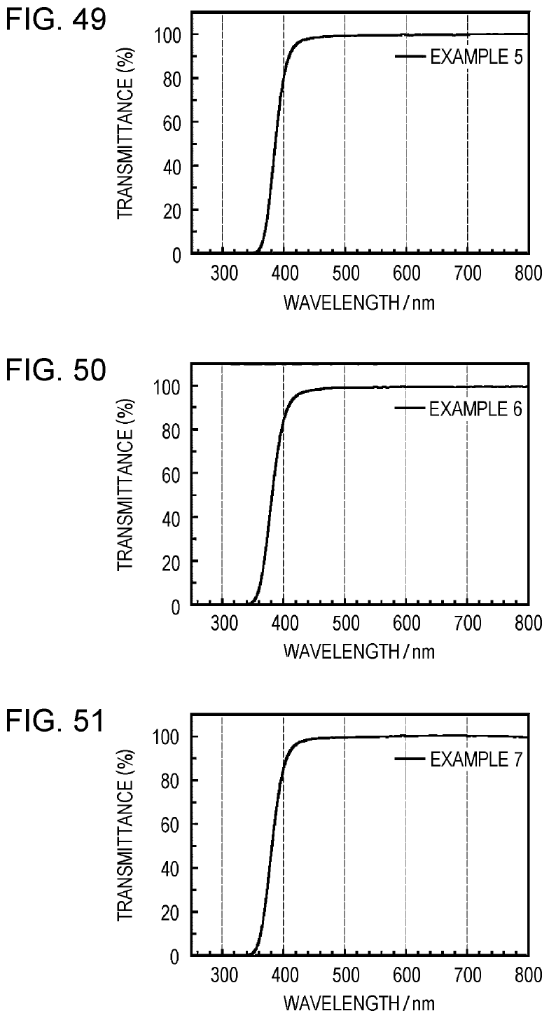

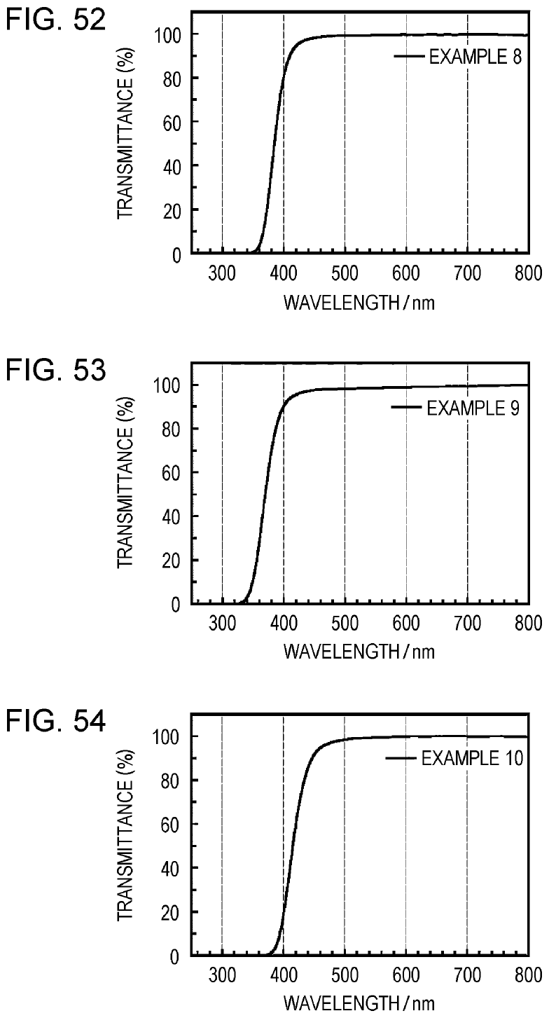

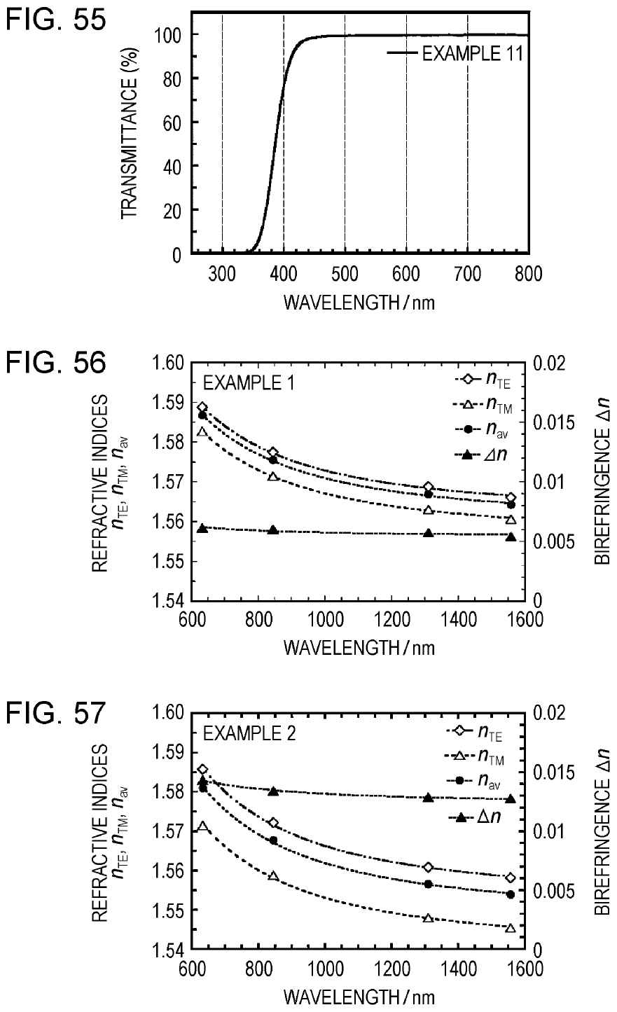

FIGS. 45 to 55 show ultraviolet-visible light transmittance spectra of the polyimide thin films (formed on quartz substrates, about 10 μm thick) of Examples 1 to 11.

Here, the thin film obtained in Example 1 had a slight opacity (haze) due to micro-scatterers present in the film. The thin films obtained in Examples 3 and 10 assumed a pale yellow color while being transparent. The thin films obtained in the other Examples (Examples 2, 4 to 9, and 11) were all colorless and transparent, had a light transmittance of 97.5% to 99.1% at a wavelength of 450 nm and exhibited a 95% light transmittance at a wavelength in the range of 415 to 423 nm, and were shown to have very high light transmission properties in the entire visible wavelength (400 to 780 nm) range. This is due to the following reason: 1,4-cyclohexanediamine (DACH) used as a diamine compound has an alicyclic skeleton, and 2,2′-bis(trifluoromethyl) benzidine (TFDB) and 5-trifluoromethyl-1,3-phenylenediamine (TFMPD) have a bulky and strongly electron-withdrawing trifluoromethyl group, as a result of which the charge-transfer properties in an electronic state formed by the moiety derived from a diamine compound and the moiety derived from trimellitic acid of a tetracarboxylic dianhydride of the polyimide in the ground state decrease, and the light absorption edge shifts from the visible range to the ultraviolet range. What is noteworthy is that, as compared with Example 2 in which the synthesis was performed using isosorbide-bis(trimellitate anhydride) alone as a tetracarboxylic dianhydride, in all of Examples 4 to 8 in which isomannide-bis(trimellitate anhydride) was added in an amount of 10 to 50 mol %, the light transmission properties improved. This is probably because the strongly bent structure derived from isomannide inhibited intermolecular aggregation of the polyimide, so that intermolecular charge-transfer light absorption was further suppressed. In addition, the polyimide of Example 10 obtained using 1,4-phenylenediamine (PPD) as a diamine compound exhibited a pale yellow color, whereas the polyimide of Example 11 obtained using 1,3-phenylenediamine (MPD), a structural isomer of 1,4-phenylenediamine (PPD), was colorless and transparent. This is also probably because the bent structure of the m-phenylene bond reduced the electron-donating properties of the moiety derived from the diamine compound and inhibited aggregation of the polyimide, so that intramolecular and intermolecular charge-transfer light absorption was suppressed.

On the other hand, the thin films obtained in Examples 3 and 10 assumed a pale yellow color probably because the benzene ring moiety of the diamine compound as a raw material and the trimellitic acid moiety of the tetracarboxylic dianhydride as a raw material had, in the ground state, an electronic state of charge transfer from the former to the latter, so that violet to blue light in the visible short wavelength range was slightly absorbed.

### <Evaluation of Refractive Index Properties>

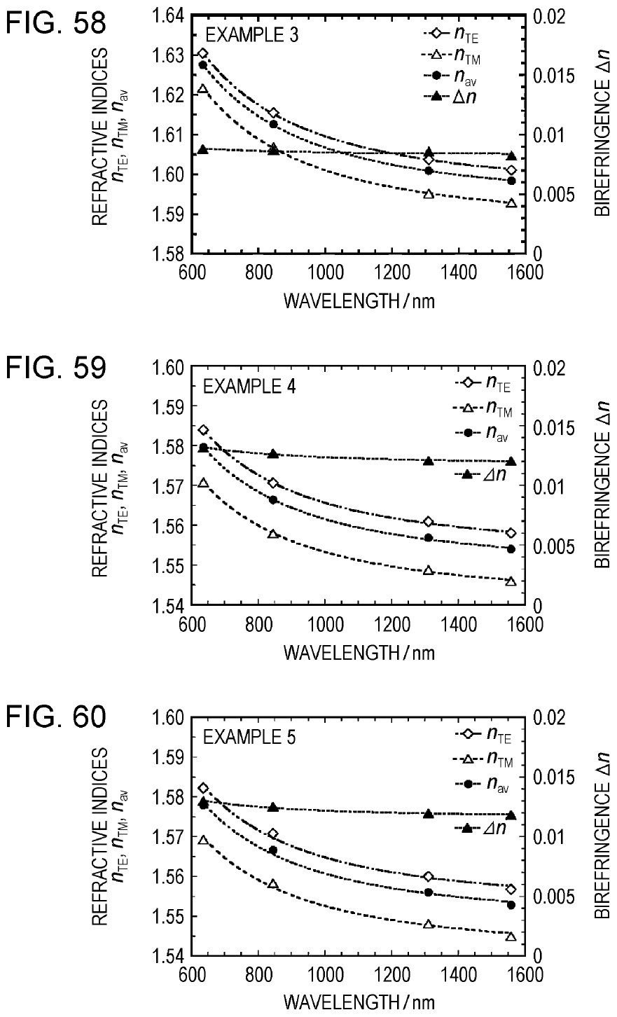

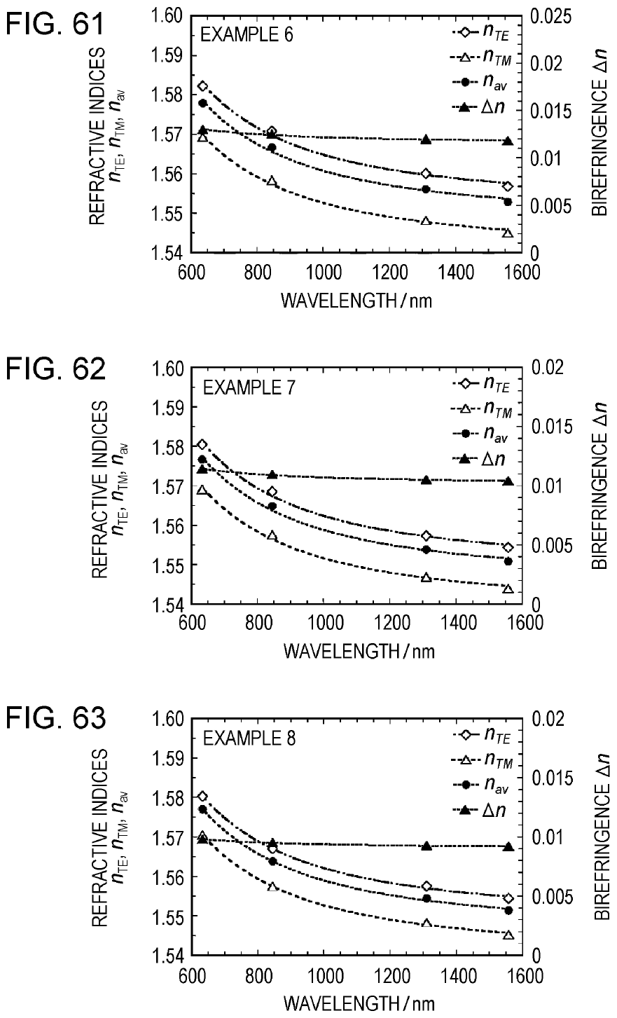

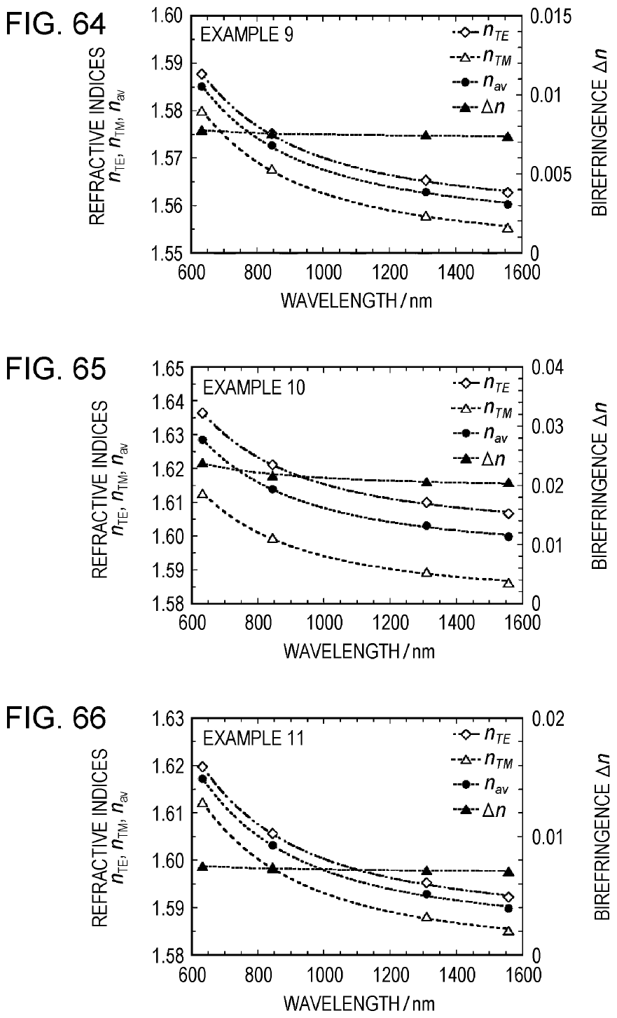

FIGS. 56 to 66 show the wavelength dependence of refractive indices (n_{TE}, n_{TM}, nₐᵥ) and birefringence (Δn) of the polyimide thin films (formed on silicon substrates, about 15 μm thick) of Examples 1 to 11. The average refractive index and birefringence measured at a wavelength of 1310 nm were listed as representative values in Table 2.

It has been shown that the polyimide thin films of Examples 1 to 11 have lower refractive indices (1.555 to 1.603) than widely used wholly aromatic polyimides. This is probably due to the low polarizability and large molecular volume of the isosorbide- or isomannide-derived alicyclic structure included in the tetracarboxylic dianhydride used.

In particular, the polyimide thin films of Examples 1, 2, 4 to 9, and 11 have refractive indices (1.555 to 1.588) markedly lower than standard average refractive indices nₐᵥ at a wavelength of 1310 nm (1.65 to 1.71, NPL 2: S. Ando et al., Japan Journal of Applied Physics, 41, 5254-5258, (2002)) of widely used wholly aromatic polyimides not including an alicyclic structure or fluorine. This is probably due to the cyclohexyl or trifluoromethyl group included in the diamine compound used as well as the isosorbide- or isomannide-derived alicyclic structure. The markedly low refractive index of the polyimide of Example 11 compared with that of Example 10 is probably because the bent structure of the m-phenylene bond inhibited intermolecular aggregation, thus resulting in lower density.

In addition, it has been shown that the polyimide thin films of Examples 1 to 11 have birefringences (0.005 to 0.021) markedly smaller than standard birefringences (Δn) at a wavelength of 1310 nm (0.026 to 0.170, NPL 3: Y. Terui et al., Journal of Polymer Science, 42, 2354-2366, (2004).) of the above widely used wholly aromatic polyimides. This is also probably due to the isosorbide- or isomannide-derived alicyclic structure which lowers the average refractive index and also inhibits molecular chain orientation and formation of aggregation structures.

In particular, the birefringences (Δn) of Examples 1, 3, 8, 9, and 11 are as very low as 0.01 or less, which is due to the bent molecular structure of the diamine compound used. Furthermore, in Examples 4 to 8 in which isomannide-bis(trimellitate anhydride) was added in an amount of 10 to 50 mol %, as compared with Example 2 in which the synthesis was performed using isosorbide-bis(trimellitate anhydride) alone as a tetracarboxylic dianhydride, the birefringence (Δn) is significantly reduced, which is also probably due to the strongly bent structure derived from isomannide.

These properties show that the polyimides of Examples 1 to 11 are excellent as heat-resistant optical materials used for optical waveguides, lightwave circuits, and the like.

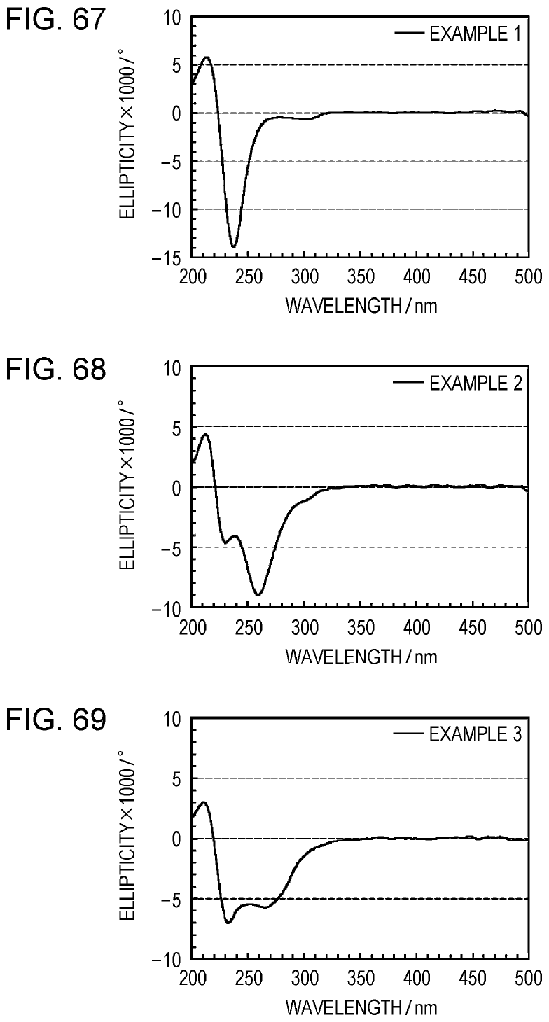

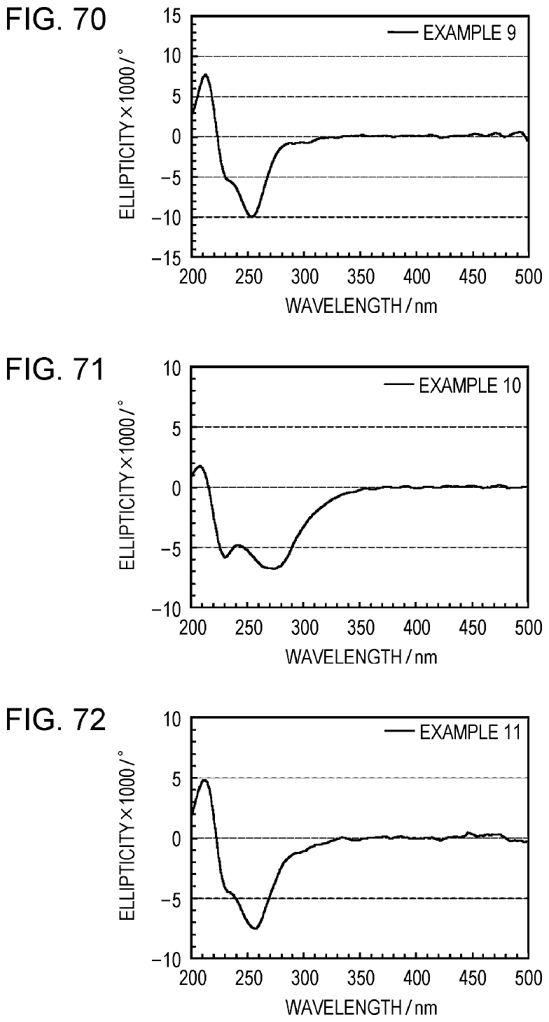

FIGS. 67 to 72 show spectra showing circular dichroism (CD) ellipticities of the polyimide thin films (formed on quartz substrates, about 1 μm thick) of Examples 1 to 3 and Examples 9 to 11, excluding the polyimide copolymers obtained using two types of acid anhydrides. Either positive or negative and wavelengths of the Cotton effect in the CD spectra are shown in Table 1.

The polyimide thin film of Example 1 has a distinct peak at a wavelength of 238 nm, the polyimide thin film of Example 2 has distinct peaks at wavelengths of 230 nm and 260 nm, the polyimide thin film of Example 3 has distinct peaks at wavelengths of 232 nm and 264 nm, the polyimide thin film of Example 9 has distinct peaks at wavelengths of 232 nm and 254 nm, the polyimide thin films of Example 10 has distinct peaks at wavelengths of 230 nm and 274 nm, and the polyimide thin film of Example 11 has distinct peaks at wavelengths of 234 nm and 254 nm, the distinct peaks each corresponding to a negative Cotton effect, and the CD signals are positive/negative pairs. This suggests that these polyimide molecules, in the solid state, retain the optically isomeric (chiral) structure of the isosorbide moiety and form a helical structure. A transparent polymer thin film forming a helical structure, when combined with an organic polymer having fluorescence or phosphorescence (photoluminescence), can exhibit circularly-polarized emission and is probably applicable to light-emitting materials for organic EL devices, optical sensors, optical radar, and 3D displays.

### <Evaluation of Dielectric Properties> (Estimated Value)

As shown in Table 2, dielectric constants (estimated values from refractive indices) (ε_{ref}) of the polyimide thin films of Examples 1 to 11, as calculated by the above formula using an average refractive index, were as small as 2.66 to 2.87. This can indicate that the polyimides have excellent dielectric properties. It has been shown that the dielectric constants are markedly smaller than standard ε_{ref} (3.0 to 3.2; observation frequency, 10 GHz; NPL 4: P. M. Hergenrother, High Performance Polymers, 15, 3-45, (2003)) of the above wholly aromatic polyimides.

### <Evaluation of Dielectric Properties> (Measured Value)

Dielectric constants (measured values) (¿) and dielectric loss tangents (measured values) of the polyimide thin films (thickness: about 15 μm) of Examples 2 to 11 at frequencies of 10 GHZ (TE mode) and 20 GHZ (TE mode) are listed in Table 2.

Here, the polyimide of Example 1 was excluded from measurement targets because it was difficult to peel a thin film with an area required for the dielectric measurement (at least 50 mm×50 mm) off the substrate. The polyimide thin films of Examples 2 to 8 had dielectric constants (measured values; frequency, 20 GHZ) of 2.88 to 2.99 and dielectric loss tangents (measured values; frequency, 10 GHz) of 0.0092 to 0.0129, which were significantly lower and smaller than dielectric constants and dielectric loss tangents of widely used polyimides. In particular, the polyimide thin films formed of copolymers of Examples 4 to 6 had smallest dielectric constants and dielectric loss tangents among all Examples, which is probably due to the molecular aggregation inhibitory effect due to the strongly bent structure of isomannide in addition to the effect of the trifluoromethyl group of the fluorine-containing diamine compound (TFDB). By contrast, the polyimide thin films of Examples 9 to 11 had dielectric constants (measured value; frequency, 20 GHz) of 3.11 to 3.25 and dielectric loss tangents (measured values; frequency, 10 GHZ) of 0.0146 to 0.0172, which were both relatively slightly high, but were equivalent to or smaller than those of the widely used polyimides.

As a whole, these dielectric properties show that the polyimides of Examples 2 to 11 having an isosorbide- or isomannide-derived structure are excellent as heat-resistant insulating materials in high-frequency substrates.

### <Evaluation of Solubility of Polyimide>

The solvent solubilities of the polyimide thin films of Examples 1 to 11 are listed in Table 3 below. In Table 3, “+” means readily soluble, “±” means poorly soluble, and “−” means insoluble.

It has been shown that the polyimide thin films obtained in Examples 2 and 4 to 9 exhibit sufficient solubility in N, N-dimethylacetamide (DMAc), N-methyl-2-pyrrolidone (NMP), and dimethylsulfoxide (DMSO) under heating at 60° C. In particular, the polyimides of Examples 7 and 8, each being a copolymer containing a relatively high proportion of isomannide, exhibited sufficient solubility also in γ-butyrolactone (GBL), but the other polyimides exhibited only slight solubility in GBL. The polyimide thin film obtained in Example 1 exhibits solubility in DMAc and NMP under heating at 60° C. and is somewhat poorly soluble in DMSO, but can be dissolved in such an organic solvent to provide a polyimide varnish. It has been shown that the polyimide thin films obtained in Example 3 and Example 11 are poorly soluble in DMAC, NMP, and DMSO under heating at 100° C. while exhibiting slight solubility and does not exhibit solubility in GBL.

TABLE 3

| | DMAc | NMP | DMSO | GBL |
|---|---|---|---|---|
| Example 1 | + | + | ± | − |
| Example 2 | + | + | + | ± |
| Example 3 | ± | ± | ± | − |
| Example 4 | + | + | + | ± |
| Example 5 | + | + | + | ± |
| Example 6 | + | + | + | ± |
| Example 7 | + | + | + | + |
| Example 8 | + | + | + | + |
| Example 9 | + | + | + | − |
| Example 10 | − | − | − | − |
| Example 11 | ± | ± | ± | − |

The polyimide thin films of Examples 1 to 11, while being bio-based polyimides made from bio-derived resources, have almost standard properties as polyimides in terms of their heat resistance (Tg, thermal decomposition temperature) and coefficient of linear thermal expansion and also exhibit excellent characteristics such as low refractive indices, small birefringences, low dielectric constants (estimated values, measured values), and small dielectric loss tangents (measured values). In addition, the polyimides shown in Examples 2, 4 to 9, and 11 exhibit very high light transmission properties (colorless transparency) in the entire visible wavelength range and also exhibit circular dichroism in the ultraviolet wavelength range and good solubility in polar organic solvents.

Taken together, it has been shown that the polyimide according to the present invention has excellent properties as a high-performance industrial material, particularly, a functional optical material or a low dielectric material.

1. A polyimide having a repeating unit represented by general formula (1) below and having a glass transition temperature (Tg) of 210° C. or higher as determined by thermomechanical analysis: 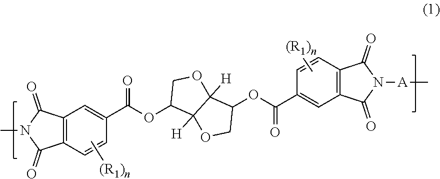
in the formula, each R₁ independently represents a non-cyclic alkyl group having 1 to 6 carbon atoms, a cyclic alkyl group having 5 or 6 carbon atoms, a non-cyclic alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a non-cyclic alkyl halide group having 1 to 6 carbon atoms, or a halogen atom, each n independently represents 0 or an integer of 1 to 3, and A represents a divalent group represented by general formula (5) below or a divalent organic group including a cyclic aliphatic group having 4 to 30 carbon atoms, 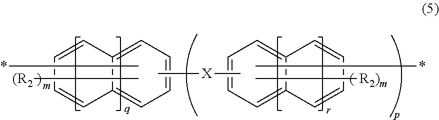
in the formula, each R₂ independently represents a 1 non-cyclic alkyl group having 1 to 6 carbon atoms, a cyclic alkyl group having 5 or 6 carbon atoms, a non-cyclic alkoxy group having 1 to 6 carbon atoms, a cyclic alkoxy group having 5 or 6 carbon atoms, an aryl group having 6 to 8 carbon atoms, an aryloxy group having 6 to 8 carbon atoms, a non-cyclic alkyl halide group having 1 to 6 carbon atoms, or a halogen atom, each m independently represents 0 or an integer of 1 to 4, p, q, and r represent 0 or 1, X represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylene group, or a fluorenylidene group, and each * represents a bonding position.

2. The polyimide according to claim 1, having, as the repeating unit, one or more repeating units selected from repeating units represented by general formulae (2) to (4) below: 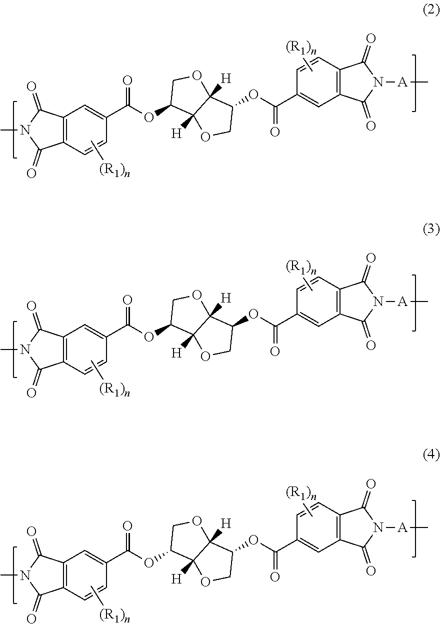
in general formulae (2) to (4), R₁, n, and A are as defined in general formula (1).

3. The polyimide according to claim 1, having, as the repeating unit, a repeating unit represented by general formula (2) below: 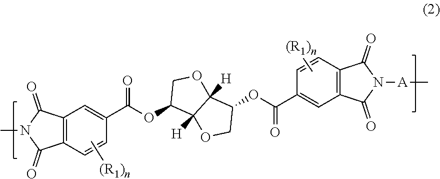
in the formula, R₁, n, and A are as defined in general formula (1).

4. The polyimide according to claim 2, wherein the one or more repeating units are two or more repeating units selected from the repeating units represented by general formulae (2) to (4).

5. The polyimide according to claim 4, wherein the two or more repeating units are the repeating units represented by general formula (2) and general formula (4).

6. The polyimide according to claim 5, wherein a molar ratio of the repeating unit represented by general formula (2) and the repeating unit represented by general formula (4), or (2):(4), is in a range of 99:1 to 50:50.

7. The polyimide according to claim 1, wherein a content of the repeating unit represented by general formula (1) is 15 mol % or more of a total amount of the polyimide.

8. A polyimide varnish comprising the polyimide according to claim 1 and an organic solvent.

9. A polyimide thin film comprising the polyimide according to claim 1.
